(19) United States
(12) Patent Application Publication
(10) Pub. No.: US 2026/0072920 A1
(43) Pub. Date: Mar. 12, 2026

(54) System And Method For Efficient Execution of Large Generative Artificial Intelligence Models on Edge Devices Using State-Space Models

(71) Applicant: BrainChip, Inc., Laguna Hills, CA (US)

(72) Inventors: M. Anthony LEWIS, La Jolla, CA (US); Yan Ru PEI, Irvine, CA (US); Jonathan TAPSON, Telluride, CO (US); Anusha Madan GOPAL, Irvine, CA (US)

(21) Appl. No.: 19/324,747

(22) Filed: Sep. 10, 2025

Related U.S. Application Data
(60) Provisional application No. 63/692,758, filed on Sep. 10, 2024.

(51) Int. Cl. G06F 16/2457; G06F 16/22; G06F 16/2455

(52) U.S. Cl. CPC G06F 16/24578; G06F 16/2237; G06F 16/2455

(57) ABSTRACT

Systems and methods for multi-source hidden-state fusion on edge devices. A processing system executes a state-space model, accesses a vector database in dynamic random-access memory, and maintains model state in on-chip static random-access memory. The system processes document chunks to form hidden states and computes a key for each chunk. Tuples pairing each key with a hidden state are stored in the database. For a received query, the system computes a query key and retrieves tuples by nearest-neighbor search using the stored keys and the query key. A fusion function computes a fused hidden state across the retrieved hidden states. The fused hidden state is loaded as the initialization state. The model processes the query tokens from that state and generates answer tokens as a function of the fused state and the query tokens.

### RELATED APPLICATIONS

This application claims the benefit of priority to U.S. Provisional Patent Application No. 63/692,758 entitled “System and Method for Efficient Execution of Large Generative Artificial Intelligence Models on Edge Devices Using State-Space Models” filed on Sep. 10, 2024, the entire contents of which are hereby incorporated by reference for all purposes.

### BACKGROUND

In recent years, edge computing devices such as smartphones, personal computers, and appliances have become increasingly powerful and complex, incorporating system-on-chips (SoCs), multiple microprocessor cores, microprocessor units (MPUs), central processing units (CPUs), digital signal processors (DSPs), graphics processing units (GPUs), neural processing units (NPUs), artificial intelligence (AI) processors, and other specialized hardware components.

Concurrent advancements in artificial intelligence (AI) and machine learning (ML) have produced highly capable large computational models, including large language models (LLMs), large speech models (LSMs), large vision models (LVMs), and large multimodal models (LMMs). Collectively referred to as large generative AI models (LXMs), these models are capable of processing and interpreting diverse data types (e.g., text, images, audio, etc.) and are increasingly used for a wide variety of applications, including natural language processing, computer vision, and speech recognition.

Due to their complexity and substantial computational demands, LXMs are typically deployed in cloud environments where they consume large amounts of computational resources. Cloud-based deployments allow these models to handle the substantial processing and power demands associated with resource-intensive tasks such as real-time text processing. However, the reliance on cloud infrastructure often introduces inefficiencies (e.g., latency, power, bandwidth, etc.) that could degrade the user experience in applications that are dependent on real-time or near-real-time responses. In contrast, deploying LXMs on edge devices or other resource-constrained devices may shift the cost of computing from the manufacturer to the customer, allowing for reduced reliance on cloud resources and potentially mitigating some of the inefficiencies associated with cloud-based models.

The growth of edge computing platforms and Internet of Things (IoT) systems has increased interest in distributing workloads between edge devices and cloud platforms. Offloading portions of LXM workloads to edge devices may improve the user experience by reducing latency and power consumption. Yet, conventional LXM architectures remain resource-intensive, and edge devices generally cannot support their execution efficiently due to limited memory and computational throughput.

Advances in recurrent neural networks and state-space AI models offer potential solutions by enabling more efficient sequence processing with reduced power requirements. However, conventional solutions have been unable to overcome the technical challenges of real-time execution of large datasets on edge devices. New and improved technical solutions that reduce memory bandwidth use, decrease processing latency, and enable offline deployment of LXMs on edge hardware will be beneficial to developers, manufacturers, and users.

### SUMMARY

Various aspects include methods performed by a processing system of an edge device that executes a first state-space model, accesses a vector database stored in dynamic random-access memory, and includes on-chip static random-access memory for model state, the method including processing a plurality of document chunks through the first state-space model to form a plurality of hidden states, computing, for each document chunk, a corresponding key, storing, in the vector database, a plurality of tuples, each tuple including a key and a hidden state, receiving, by the processing system, a first query, computing a query key for the first query, retrieving, from the vector database, a set of tuples selected by a nearest-neighbor search that uses the stored keys and the query key, computing a fused hidden state by applying a fusion function across hidden states of the set of tuples, loading the fused hidden state into the on-chip static random-access memory of the edge device as an initialization state of the first state-space model, processing tokens of the first query through the first state-space model from the initialization state, and generating answer tokens as a function of the fused hidden state and the tokens of the first query.

In some aspects, the fusion function may compute a weighted sum across the hidden states of the set of tuples. In some aspects, the weighted sum may include weights computed by a lexical scorer and a semantic scorer and a cross-encoder. In some aspects, the fusion function applies identical relevance weights across layers of the first state-space model. In some aspects, the fusion function applies per-layer weights derived from global relevance weights. In some aspects, the processing system performs retrieval of the set of tuples as a stream layer by layer and accumulates the fused hidden state per layer to reduce memory footprint. In some aspects, the processing system dynamically selects a number of tuples for fusion in response to a coverage metric that depends on a spread of relevance scores. In some aspects, computing each key may include applying a linear projection to the corresponding hidden state. In some aspects, computing each key may include computing a sentence-embedding vector. In some aspects, the processing system executes the first state-space model on a neural processing unit or a digital signal processor or a graphics processing unit of the edge device.

Some aspects also include methods performed by a processing system of an edge device that executes a first state-space model, accesses a vector database stored in dynamic random-access memory, includes on-chip static random-access memory for model state, which may include processing a first document chunk through the first state-space model to form a first hidden state, computing a first key for the first document chunk, storing, in the vector database, a first tuple that includes the first key and the first hidden state, receiving, by the processing system, a first query, computing a query key for the first query, retrieving the first tuple from the vector database by a nearest neighbor search that uses the first key and the query key, loading the first hidden state into the on-chip static random-access memory of the edge device as an initialization state of the first state-space model, processing tokens of the first query through the first state-space model from the initialization state, and generating answer tokens as a function of the initialization state and the tokens of the first query without reprocess of tokens of the first document chunk.

In some aspects, the methods may further include computing the first key as a sentence-embedding vector. In some aspects, the methods may further include computing the first key by applying a linear projection to the first hidden state. In some aspects, the methods may further include computing the first key by applying a multilayer perceptron with fixed parameters to the first hidden state. In some aspects, the methods may further include storing the first tuple as two contiguous arrays of floating-point values in dynamic random-access memory. In some aspects, the methods may further include performing the nearest neighbor search by cosine similarity and selecting a highest-scored tuple. In some aspects, the methods may further include processing the first query through the first state-space model to form a query hidden state and computing the query key by applying a same function used to compute the first key to the query hidden state. In some aspects, the methods may further include storing the first tuple as non-text numeric arrays that encode the first document chunk by the first key and the first hidden state. In some aspects, the methods may further include executing the first state-space model on a neural processing unit or a digital signal processor or a graphics processing unit of the edge device. In some aspects, the methods may further include transferring the first hidden state by direct memory access into per-layer static random-access memory locations of an accelerator of the edge device before a first token of the first query enters the first state-space model.

Some aspects also include methods performed by a processing system of an edge device that include processing a corpus through a first state-space model to form a stored hidden state, computing a retrieval index vector for the corpus, storing, in a vector database, a tuple that includes an identifier for the corpus, the retrieval index vector, and the stored hidden state, receiving a user query and a selection of the identifier, retrieving the tuple by the identifier, loading the stored hidden state into on-chip static random-access memory of the edge device as an initialization state of the first state-space model, processing tokens of the user query from the initialization state, and generating answer tokens.

In some aspects, loading the stored hidden state may include direct memory access that copies one per-layer vector into per-layer static random-access memory locations of a neural processing unit or a digital signal processor or a graphics processing unit. In some aspects, the methods may further include storing multiple tuples for multiple corpora and switching context by retrieving and loading the stored hidden state of a different tuple in response to a user selection. In some aspects, the methods may further include retrieving multiple stored hidden states for multiple corpora and forming a combined hidden state by a fusion function that computes a weighted sum per layer or applies a learned per-layer mapper before load.

Further aspects may include a computing device having at least one processor or processing system configured with processor-executable instructions to perform various operations corresponding to the methods discussed above. Further aspects may include a computing device having various means for performing functions corresponding to the method operations discussed above. Further aspects may include a non-transitory processor-readable storage medium having stored thereon processor-executable instructions configured to cause at least one processor or processing system to perform various operations corresponding to the method operations discussed above.

### BRIEF DESCRIPTION OF THE DRAWINGS

The accompanying drawings, which are incorporated herein and constitute part of this specification, illustrate exemplary aspects of the invention and, together with the general description given above and the detailed description given below, serve to explain the features of the disclosure.

FIG. 1 is a component diagram of an on-chip system (SoC) suitable for implementing some embodiments.

FIG. 2 is a component block diagram of components in a system configured to apply input to a large generative AI model (LXM) in retrieval-augmented generation (RAG) mode in accordance with some embodiments.

FIGS. 3A-3C are component block diagrams of systems configured to preprocess and store state token strings that may be reused in some embodiments.

FIG. 3D is a process flow diagram that illustrates an example method of offline precognition record creation and single-source query-time reuse on a state-space model in accordance with some embodiments.

FIG. 3E is a process flow diagram that illustrates a tuple-centric embodiment that stores a tuple [key, hidden_state] in a vector database and retrieves the tuple by nearest neighbor search for reuse on a state-space model in accordance with some embodiments.

FIG. 4A is a process flow diagram of an example RAG flow for edge devices in accordance with some embodiments.

FIG. 4B is a process flow diagram illustrating a method of voice interaction on an edge device that converts microphone input to a text query, retrieves one stored hidden state obtained through precomputation or k stored hidden state obtained through precomputations, forms a combined hidden state, and generates output audio in accordance with some embodiments.

FIG. 5A is a process flow diagram of an example precognition flow for edge devices in accordance with some embodiments.

FIG. 5B is a process flow diagram illustrating a method of training and inference with trainable initialization tensors and multi-prompt fusion that form an initialization state for an SSM in accordance with some embodiments.

FIG. 5C is a process flow diagram illustrating a method of incremental text entry with snapshot identifiers and time-reversal rollback that restores a prior hidden state in response to a deletion event in accordance with some embodiments.

FIG. 6A is a process flow diagram of a method of executing an LXM on an edge device in accordance with some embodiments.

FIG. 6B is a process flow diagram illustrating a method of self-key retrieval from a hidden state that computes an index from a query hidden state and retrieves a stored tuple [key, hidden_state] by nearest neighbor search for reuse in accordance with some embodiments.

FIG. 7A is a process flow diagram of a RAG flow using multiple information sources for edge devices in some embodiments in accordance with some embodiments.

FIG. 7B is a process flow diagram illustrating a method of query-adaptive multi-stage retrieval that combines lexical semantic and QA relevance scores and selects k based on a coverage metric in accordance with some embodiments.

FIG. 7C is a process flow diagram of query-adaptive multi-stage retrieval with dynamic k that combines a lexical stage a semantic stage and a QA relevance ranking stage. Examples may include BM25 for the lexical stage and cosine similarity for the semantic stage and a QA relevance ranker for QA relevance ranking.

FIG. 8 is an image of exemplary pseudocode implementing a RAG system using multiple information sources on edge devices in accordance with some embodiments.

FIG. 9 is a component block diagram of an edge device in the form of a headset suitable for implementing some embodiments.

FIG. 10 is a component block diagram of an edge device in the form of a laptop suitable for implementing some embodiments.

FIG. 11 is a component diagram of a server suitable for implementing some embodiments.

### DETAILED DESCRIPTION

The various embodiments may be described in detail with reference to the accompanying drawings. Wherever possible, the same reference numbers may be used throughout the drawings to refer to the same or similar parts. References made to particular examples and implementations are for illustrative purposes and are not intended to limit the scope of the invention or the claims.

The word “exemplary” may be used herein to mean “serving as an example, instance, or illustration.” Any implementation described herein as “exemplary” is not necessarily to be construed as preferred or advantageous over other implementations.

In overview, the embodiments allow for the efficient deployment of large language models (LLMs) or other large generative AI models (LXMs) on resource-constrained devices (e.g., edge devices, etc.). The embodiments address limitations in computation and memory, reduce reliance on high-speed memory, and improve throughput by reusing compact hidden states. The embodiments allow real-time inference and improve power efficiency and memory management by shifting large portions of context processing to an offline or precomputation stage, thereby reducing runtime operations to only query-time processing of new tokens.

In some embodiments, the processing system may form one stored hidden state for a known corpus such as a book by running the corpus through a state-space model in a precog stage. The processing system may store a tuple that includes an identifier for the corpus, a retrieval index vector, and the stored hidden state. At query time the processing system may load the stored hidden state as the initialization state and process query tokens without replay of the corpus. The processing system may keep multiple tuples for multiple corpora and may switch context by selecting a different tuple for load.

The term “computing device” may be used herein to refer to devices that include memory and programmable processors capable of executing machine learning algorithms or other computational tasks to provide the functionality described herein. Examples of computing devices include server computing devices, personal computing devices, desktop computers, laptops, tablets, smartphones, wearable devices (e.g., smartwatches), Internet of Things (IoT) devices (e.g., smart speakers, smart thermostats, smart home hubs, smart displays), connected vehicles, autonomous vehicles, drones, and audio devices (e.g., smart speakers).

The term “processing system” may be used herein to refer to hardware that includes one or more processors, memory, interconnect, and input-output resources that perform operations described herein. A processing system may execute processor-executable instructions or may control a state machine that performs the operations. The state machine may be implemented as microcode, firmware, programmable logic, or logic circuitry. The processing system may reside within a system-on-chip (SoC) or a system-in-a-package (SiP). A non-transitory processor-readable storage medium may store data and configurations that control the state machine or cause a processor in the processing system to perform method operations described herein.

The term “state machine” may be used herein to refer to a computer-implemented configuration executed by a processor or embodied in logic circuitry that defines a set of states and transitions between the states. In some embodiments, a state machine may be implemented as microcode, firmware, programmable logic, or software that operates on a processor. A non-transitory processor-readable storage medium may store data and configurations that control a state machine or cause a processor to perform method operations described herein.

The term “system-on-chip” (SoC) may be used herein to refer to a single integrated circuit (IC) chip that includes multiple resources or processors on a single substrate. A single SoC may include digital, analog, mixed-signal, and radio-frequency circuitry. A single SoC may include at least one processor of a processing system that includes any number of general-purpose or specialized processors (e.g., network processors, digital signal processors, modem processors, video processors, etc.), memory blocks (e.g., ROM, RAM, Flash, etc.), and resources (e.g., timers, voltage regulators, oscillators, etc.). For example, an SoC may include an application processor that operates as the SoC's main processor, central processing unit (CPU), microprocessor unit (MPU), etc.). Each such processor may include one or more arithmetic logic units (ALUs). An SoC processing system may include software for controlling integrated resources and processors. In some embodiments, an SoC may include a neural processing unit (NPU), a digital signal processor (DSP), or a graphics processing unit (GPU) for on-device execution of a state-space model (SSM). The SoC may pair with Double Data Rate 4 (DDR4) Synchronous Dynamic Random-Access Memory (SDRAM) or Double Data Rate 5 (DDR5) SDRAM and may store compact, hidden states without high-bandwidth memory (HBM). The SoC may support precomputation and query-time operations described herein.

The term “system-in-a-package” (SiP) is used herein to refer to a single module or package that contains multiple resources, computational units, cores, or processors on two or more IC chips, substrates, or SoCs. For example, a SiP may include a single substrate on which multiple IC chips or semiconductor dies are stacked vertically. Similarly, the SiP may include one or more multi-chip modules (MCMs) on which multiple ICs or semiconductor dies are packaged into a unifying substrate. A SiP may also include multiple independent SoCs coupled together via high-speed communication circuitry and packaged in close proximity, such as on a single motherboard, in a single user equipment (UE), or a single CPU device. The proximity of the SoCs may support high-speed communications and the sharing of memory and resources. In some embodiments, a SiP may support on-device execution of an SSM, storage of compact hidden states in standard-performance memory, and precomputation and query-time operations for retrieval-augmented generation (RAG) on an edge device.

The terms “machine learning algorithm” and “artificial intelligence model” and similar terms may be used interchangeably herein to refer to a variety of computational models or information structures that may be used by a computing device to perform tasks, computations, or evaluations. Examples of machine learning algorithms include neural network models, inference models, classifiers, random forest models, spiking neural network (SNN) models, convolutional neural network (CNN) models, recurrent neural network (RNN) models, state-space models (SSMs), deep neural network (DNN) models, generative adversarial networks (GANs), ensemble networks, and genetic algorithm models. In some embodiments, a machine learning algorithm may include an architectural definition, weight values, and one or more hidden-state representations that support precomputation and reuse during query-time operations.

The term “neural network” may be used herein to refer to an interconnected group of processing nodes that collectively operate as a software application or process that controls a function of a computing device and/or generates an overall inference result as output. Individual nodes in a neural network may emulate biological neurons by receiving input data, performing simple operations on the input data to generate output data, and passing the output data (also called “activation”) to the next node in the network. Each node may be associated with a weight value that defines the relationship between input data and output data. A neural network may learn to perform new tasks over time by adjusting these weight values. In some cases, the overall structure of the neural network and/or the operations of the processing nodes remain unchanged as the neural network learns a task. Rather, learning is accomplished during a training process in which the values of the weights in each layer are determined. As an example, the training process may include causing the neural network to process a task for which an expected output is known, comparing the activations generated by the neural network to the expected output, and determining the values of the weights in each layer based on the comparison. After the training process is complete, the neural network may perform inference to process a new task with the determined weights.

The term “inference” may be used herein to refer to a process that is performed at runtime or during the execution of the software application program corresponding to the machine learning algorithm. Inference may include traversing the processing nodes in a network (e.g., neural network, etc.) along a forward path to produce one or more values as an overall activation or inference result. In some embodiments, inference may include initializing a model with a stored hidden state, processing query tokens as part of query-time operations, and generating output based on the updated hidden state.

The term “deep neural network” may be used herein to refer to a neural network that implements a layered architecture in which the output of a first layer of nodes becomes an input to a second layer of nodes, the output of a second layer becomes an input to a third layer, and so on. The first layer may be an input layer. The final layer may be an output layer. Intermediate layers lie between the input and the final layers.

The term “recurrent neural network” (RNN) may be used herein to refer to a class of neural networks suited for sequence data processing. Unlike feedforward neural networks, an RNN may include cycles that allow information to persist. This allows an RNN to maintain a memory of previous inputs in the sequence. In some embodiments, an RNN may expose a hidden state that a processing system may reuse or initialize to support on-device query-time operations.

The term “transformer” may be used herein to refer to a neural network that includes an encoder or a decoder and is suited for sequence data processing. Transformers may use multiple self-attention components to process input data in parallel. The self-attention components may weigh different parts of an input sequence when producing an output sequence and may compute a weighted sum of positions in the input sequence for each position. The model may consider other parts of the sequence when encoding each element. This may benefit tasks that use contextual relationships between elements in a sequence, such as sentence completion, translation, and summarization. Training may determine the weights. Transformers often serve as foundational elements in constructing conventional large generative AI models (LXMs).

The term “large generative AI model” (LXM) may be used herein to refer to an advanced computational framework that includes specialized AI models such as large language models (LLMs), large speech models (LSMs), large vision models (LVMs), vision-language models (VLMs), hybrid models, and multimodal models. An LXM may include multiple layers of neural networks such as recurrent neural networks, transformer networks, or state-space models (SSMs) including variants such as Temporal Event-Based Neural Networks (TENNs). An LXM may include millions or billions of parameters. LXMs support dialogic interactions and encapsulate knowledge in an internal structure. LXMs may provide direct answers and may perform tasks such as text summarization, translation, complex question answering, and conversational interaction. LXMs may operate as standalone units or may be integrated into other systems, such as a SoC or a SiP, and may interface with hardware accelerators to improve latency and throughput. In some embodiments, an LXM may include an adaptive algorithm that improves context handling or evaluation of weights between nodes in a feature graph. In some embodiments, a processing system may perform the adaptive algorithm or may distribute it across multiple processing systems. In some embodiments, an LXM that implements a state-space model may maintain a fixed-length hidden state to support precomputation, storage, and reuse on an edge device.

For ease of reference and to focus the discussion on the most relevant features, some of the embodiments below are discussed with reference to an LLM. However, it should be understood that the embodiments may be applicable to any LXM. As such, nothing in this application should be used to limit the claims to LLMs unless expressly recited as such in the claims.

The term “relevance model” may be used herein to refer to a trained computational unit executed by a processing system that evaluates the pertinence of candidate data with respect to a query. A relevance model may assign numeric scores to data chunks stored in memory. A processing system may use the scores to select documents, chunks, or stored hidden states during retrieval-augmented generation (RAG) or other query-time operations. The relevance model may be implemented as a neural network, a classifier, or another trained function deployed on edge hardware or server systems.

The term “high-dimensional vector” may be used herein to refer to a computer-implemented data structure stored in memory that encodes attributes of a token, image feature, or other data element. Each dimension of the vector may correspond to a value that represents an attribute or a learned feature. A processing system may generate, store, and manipulate high-dimensional vectors in memory as part of operations such as similarity comparison, retrieval, or hidden-state initialization. In some embodiments, high-dimensional vectors may be stored in volatile or non-volatile memory as multidimensional arrays or tensors accessible to processors within a SoC or a SiP.

The term “embedding layer” may be used herein to refer to a neural network layer executed by a processing system that maps tokens into continuous vector representations. An embedding layer may convert tokens into vectors of fixed dimension and may update the vectors during training so that the vectors capture semantic or structural attributes.

The term “token” may be used herein to refer to a computer-readable data element that represents a unit of input that an LXM may read as a single input during training and inference. In text-centric models, a token may represent a paragraph, a sentence, a clause, a word, a sub-word, or a character. In auditory models, a token may represent a phoneme, a spectrogram frame, or a Mel-frequency cepstral-coefficient vector. In visual models, a token may represent a portion of an image or a sequence of video frames. In multimodal systems, a token may include both textual and visual information. A processing system may store tokens in memory. A processing system may convert tokens into vectors using an embedding layer. A processing system may process tokens through layers of a neural network.

The system may convert each token into a numerical vector using an embedding layer. Each vector component may encode an attribute of the original token. During operation, the system may process tokens through layers of the LXM. The model may include transformer layers or recurrent layers such as long short-term memory layers. The numerical vectors may use a fixed dimension such as 512, 768, or 2048. In some embodiments, an SSM may update a fixed-length hidden state as the system processes tokens and may reuse the hidden state during query-time operations on an edge device.

The term “sequence data processing” may be used herein to refer to a process performed by a processing system that operates on an ordered set of tokens and preserves dependencies among the tokens. Sequence data processing may include generating a probability distribution over candidate next tokens, selecting or sampling from that distribution, and appending a token to extend the sequence.

The term “state-space model” (SSM) may be used herein to refer to a type of computational model particularly well-suited for handling sequence data by maintaining a compact hidden state that evolves over time based on the input data. SSMs process input data serially, updating the hidden state at each step, where the hidden state captures prior information without growth in size as more data is processed. That is, the hidden state captures all prior information without increasing in size as more data is processed. SSMs may be distinct from traditional recurrent neural networks (RNNs) because, for example, they offer more efficient memory usage and are more suitable for use on resource-constrained devices such as edge devices. In some embodiments, SSMs may be integrated with machine learning algorithms or LXMs for more efficient processing of large datasets, including natural language inputs, while reducing resource usage requirements. SSMs may be particularly beneficial in systems that benefit from real-time sequence processing, including retrieval-augmented generation (RAG) systems and other advanced AI-driven applications that could be implemented and used on edge devices.

For ease of reference and to focus the discussion on the most relevant features, some of the embodiments below are discussed with reference to an SSM. However, it should be understood that the embodiments may be applicable to any recurrent computational model. As such, nothing in this application should be used to limit the claims to SSMs unless expressly recited as such in the claims.

The term “hidden state” may be used herein to refer to an internal representation maintained by a computational model (e.g., SSM, etc.) during the processing of input data. A hidden state may encapsulate the computational model's memory of previously processed information and may evolve as new data is processed. In some embodiments, the hidden state may be represented as a fixed-length vector that is updated sequentially as additional input is processed to allow the computational model to retain relevant information about past inputs without increasing the size of the representation. In some embodiments, the hidden state may capture and store information about an input sequence, such as to allow for context-aware processing in tasks such as inference or RAG. In some embodiments, the hidden state may serve as a compact summary of the processed data that may be used to continue processing new data, generate responses, or retrieve relevant information without the need to reprocess previous inputs.

The term “retrieval augmented generation” (RAG) may be used herein to refer to a technique that combines the retrieval of relevant data from a database with the generative capability of an LXM. In response to a query, the system may retrieve relevant context using a vector database or another knowledge base and provide the retrieved context to the model. In some embodiments, RAG may integrate with an SSM by retrieving one or more stored hidden states that correspond to relevant data chunks and by initializing the model with the retrieved hidden state or a fused hidden state. This solution may reduce memory access, computation, and latency during query processing on an edge device.

The term “data chunk” may be used herein to refer to a subset of a dataset that a computing system may process individually. A data chunk may include units of text, audio, or image data. The system may tokenize a data chunk and may convert tokens into high-dimensional vectors during processing by a model. The size and format of a data chunk may vary by application, such as sentences or paragraphs for text or image sections for vision. The system may process, store, and retrieve data chunks independently or in combination to generate results during inference, retrieval-augmented generation, or sequence data processing. In some embodiments, the system may store one stored hidden state per data chunk and may associate that stored hidden state with a key for retrieval. In some embodiments, the system may organize and select data chunks to improve memory use and computational efficiency while maintaining compact hidden states as new data chunks are processed.

The term “document chunk” may be used herein to refer to a data chunk that originates from a document or a corpus and that the system treats as a unit for retrieval and precomputation. A document chunk may correspond to a sentence or a paragraph or a section or a table caption or a figure caption. A document chunk may include a document identifier and a chunk identifier and a position index. The system may tokenize a document chunk and may form a stored hidden state that summarizes tokens of the document chunk and may link that stored hidden state to a key for retrieval. The system may bound a document chunk by a token budget for offline precomputation. The system may persist a tuple that includes the key and the stored hidden state for each document chunk in a vector database and may retrieve one tuple for reuse during query-time operations.

The term “query-time operations” may be used herein to refer to runtime operations that use one stored hidden state or multiple stored hidden states. Example query-time operations may proceed as follows. The system may receive a query as a sequence of tokens and may compute a key that serves as a retrieval index for locating a stored hidden state. The system may search a vector database and may retrieve one stored hidden state or multiple stored hidden states that match the key. The system may compute a combined hidden state when selecting multiple sources and may initialize the SSM with either a stored hidden state or the combined hidden state. The system may process the query tokens, update an intermediate hidden state, generate output tokens that form a response, and present the response through a display or an audio interface. In some embodiments, query-time operations may include a rollback that returns the hidden state to reflect a user edit without reprocessing earlier tokens.

The term “key” may be used herein to refer to a retrieval index vector for locating a stored hidden state. A key may take the form of a sentence embedding or another vector representation. In some embodiments, a key may match a key associated with a stored [key, hidden_state] tuple in a vector database. In some embodiments, a processing system may use the key with one scoring method or multiple scoring methods to select one stored hidden state or multiple stored hidden states for initialization or fusion.

The term “rollback” may be used herein to refer to an operation that returns the SSM hidden state to a prior point in a sequence without full re-computation. A user interface may capture text entry events and deletion events during query composition. The processing system may update the hidden state as the user adds input tokens and may revert the hidden state after a deletion event.

The various embodiments include methods (and computing devices, processing systems, and components configured to implement methods) for configuring, deploying, and operating LLMs or other LXMs on edge devices. The embodiments address technical challenges associated with running LLMs on edge devices. The embodiments reduce compute demand, memory bandwidth demand, and reliance on high-speed memory.

Conventional solutions for running LLMs, especially those based on transformer architectures, require substantial computational power and memory bandwidth. Edge devices typically have more limited resources compared to cloud-based systems and often cannot support these models efficiently. The memory available on these devices ranges from high-speed options, such as High Bandwidth Memory (HBM), to more affordable standard-performance options, including DDR4 SDRAM and DDR5 SDRAM. Conventional solutions that compress models, improve inference processes, or add hardware accelerators still rely on high-speed memory and substantial computational resources, which renders them unsuitable for deployment on edge devices.

In some embodiments, the processing system may be configured to overcome these and other limitations of conventional solutions by using recurrent computational models, such as SSMs, that handle LLMs more efficiently on resource-constrained devices. An SSM maintains a compact hidden state represented as a fixed-length vector whose dimensionality is defined by the model and does not increase with context length. This property may reduce memory consumption and support the use of SSMs in edge devices.

In some embodiments, the processing system may precompute stored hidden states for input text that is likely to be reused, such as in RAG systems. Precomputation may allow the system to store the hidden states in compact form and reuse them during query-time operations without processing the same text multiple times. In real-time query processing, the system may load the stored hidden state corresponding to a known context and process the query from that point forward. This may eliminate the need to process the known context during runtime, thereby improving speed and responsiveness while reducing computational overhead.

In some embodiments, the processing system may improve memory efficiency by reducing memory access during LLM processing. Conventional solutions for large inputs often recompute activations and repeatedly access parameters for each token. By loading stored hidden states, the system may reduce memory bandwidth use and improve overall processing efficiency.

Conventional flows for large contextual inputs may result in response times that extend beyond practical real-time interaction. For example, some conventional solutions for processing large amounts of contextual information require long delays before generating responses. By precomputing stored hidden states and handling queries more efficiently in accordance with the embodiments, the processing system may reduce processing times by orders of magnitude. A user may receive a response in real time because only the query tokens are processed during runtime. This reduction in processing time may improve responsiveness and reduce power consumption on the device.

In some embodiments, the processing system may store context information as a [key, hidden_state] tuple rather than as large groups of vectors. In some embodiments, the hidden state may store a compact representation of context. In some embodiments, this structure may reduce memory footprint, improve storage efficiency, and reduce bandwidth demand during database updates.

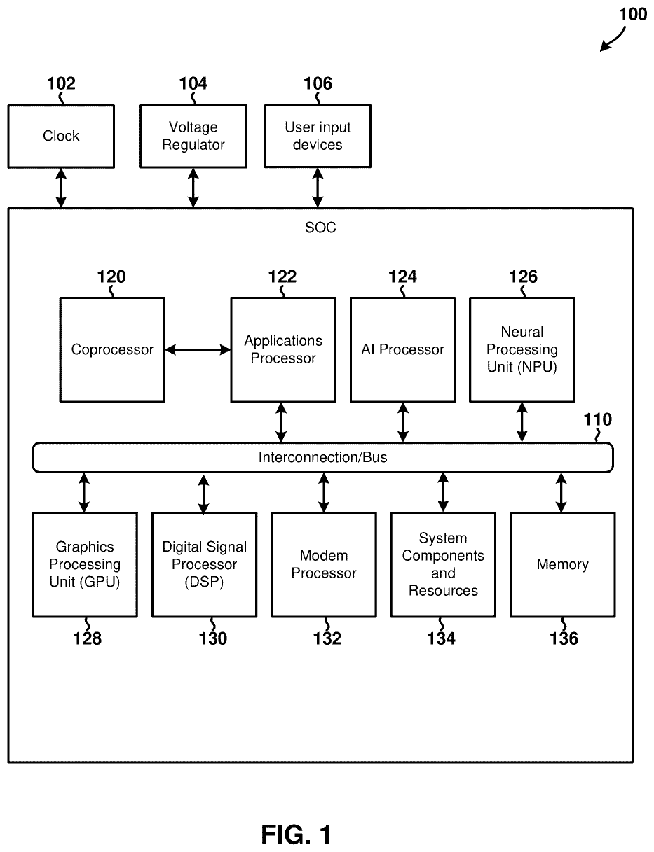

Various embodiments may be implemented in single-processor or multiprocessor computer systems, including a SoC or SiP. FIG. 1 illustrates an example computing system or SoC 100 architecture that may be included in devices implementing the various embodiments.

In the example illustrated in FIG. 1, the SoC 100 includes a clock 102, a voltage regulator 104, and user input devices 106 such as touch-sensitive displays, microphones, and cameras. The SoC 100 integrates processors that include a coprocessor 120, such as a vector coprocessor, an applications processor 122, an AI processor 124, and a neural processing unit (NPU) 126. Additional components include a graphics processing unit (GPU) 128, a digital signal processor (DSP) 130, a modem processor 132, memory 136, and system components and resources 134. The processors and components may connect through an interconnection or bus 110 that may use networks-on-chip (NoCs), reconfigurable logic arrays, or bus architectures such as CoreConnect or AMBA.

In some embodiments, selected processors in the SoC 100, such as the applications processor 122 or modem processor 132, may function as a central processing unit (CPU) or a microprocessor unit (MPU). Each such processor may include one or more arithmetic logic units (ALUs). The SoC 100 may execute software programs and may perform arithmetic, logical, control, and input/output operations as specified by processor-executable instructions. One or more coprocessors 120 may assist the CPU during these operations.

Each processor 120-132 may include one or more cores, and each processor or core may perform operations independently of the others. For example, the SoC 100 may include one processor that executes a first operating system, such as FreeBSD or Linux, and another processor that executes a different supported operating system.

In some embodiments, processors 120-132 may operate in clusters. A cluster may include heterogeneous cores within a single SoC or distributed nodes spanning multiple SoCs. Each node may include an operating system, a CPU, memory, and storage. The system may divide a computational task among the nodes, and the system may combine partial results to produce a final result faster than on a single processor. Clusters may also improve fault tolerance and throughput by distributing tasks across multiple nodes.

The SoC 100 may include system components and resources for sensor data management, wireless transmission, analog-to-digital conversion, and specialized tasks such as AI inference or precomputation of stored hidden states for frequently used input text. These components may include power amplifiers, voltage regulators, oscillators, phase-locked loops, data controllers, memory controllers, and peripheral bridges. The system components may support communication with peripheral devices such as cameras, microphones, external displays, and wireless communication modules.

The SoC 100 may include an input/output module for interfacing with external resources, such as user input devices 106 and wireless transceivers, including Bluetooth or cellular transceivers. These external resources may be shared among processors or cores in the SoC 100.

In addition to the SoC 100, the embodiments may be implemented in other computing systems, including systems with single or multicore processors, multiple processors, or hybrid configurations that integrate different processing technologies.

Recurrent SSM may achieve efficient processing by maintaining compact hidden-state representations rather than storing activations that grow with sequence length.

In an SSM, the network maintains a hidden state that represents tokens processed up to the current time. The hidden state may have a fixed dimensionality that does not increase as the length of the input context grows. In some embodiments, the dimensionality of the hidden state may equal the token embedding dimensionality. In other embodiments, the dimensionality may be larger or smaller, depending on the model design.

An SSM may process an input context sequentially up to a defined point in the sequence. At that point, the model maintains a hidden state that encapsulates the information from the tokens already processed. The hidden state may serve as a fixed-length representation that preserves contextual dependencies without growth in size as additional tokens are processed. The processing system may reuse the stored hidden state as the starting condition for subsequent computations, including continuation of the sequence or processing of new query tokens. By reusing the hidden state in this manner, the system may avoid reprocessing tokens that have already contributed to the model's representation, reduce computational overhead, and improve runtime efficiency on edge devices. These operations may improve computer functionality by reducing memory use and processing demand while maintaining context awareness.

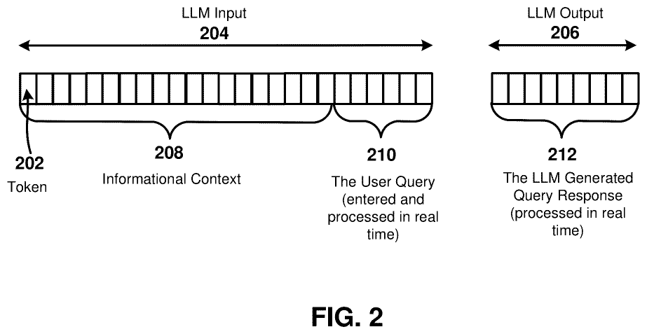

FIG. 2 illustrates an input and output token sequence for an LLM, an example of an LXM, operating RAG mode in accordance with some embodiments. FIG. 2 shows tokens 202 along an LLM input timeline 204 and an LLM output timeline 206. The LLM input timeline 204 includes an informational context segment 208 and a user query segment 210. The LLM output timeline 206 includes a query response segment 212.

A processing system may ingest tokens 202 along the LLM input timeline 204. The system may maintain a hidden state that summarizes the informational context segment 208 and may continue updating the hidden state while processing the user query segment 210. The system may generate tokens on the LLM output timeline 206, assemble them into the query response segment 212, and present them as the generated answer.

In some embodiments, the system may initialize an SSM with a stored hidden state obtained from a precomputation process. The stored hidden state may represent the informational context segment 208. The system may then process the user query segment 210 without reprocessing the informational context segment 208. These operations may reduce memory traffic, lower computational demand, and decrease latency during query-time operations on an edge device.

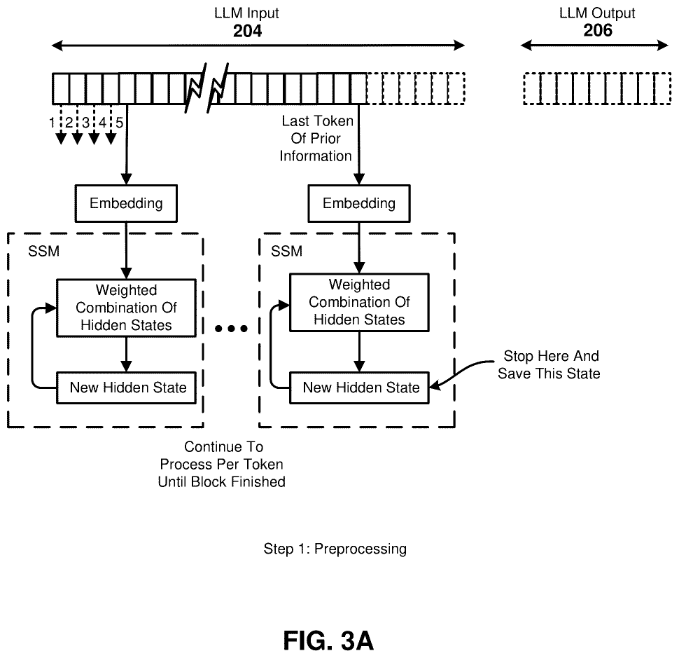

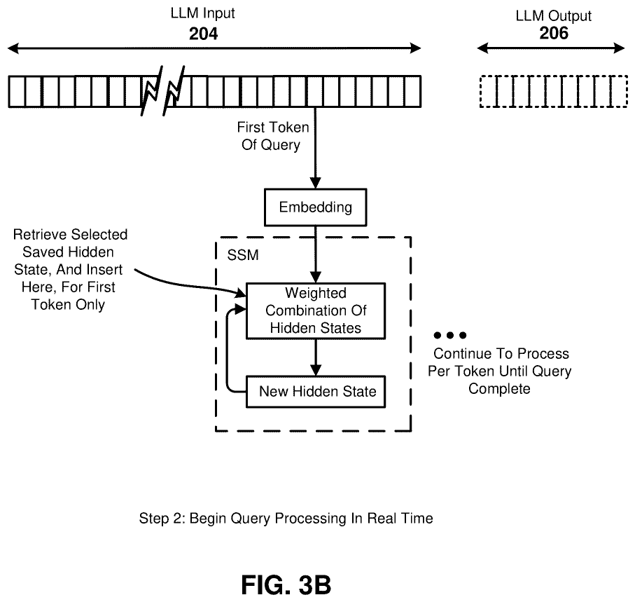

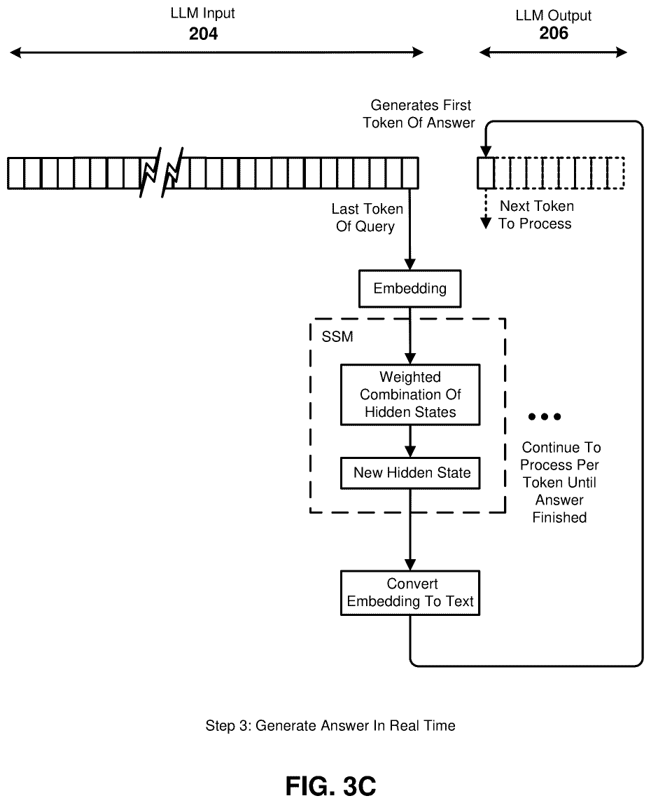

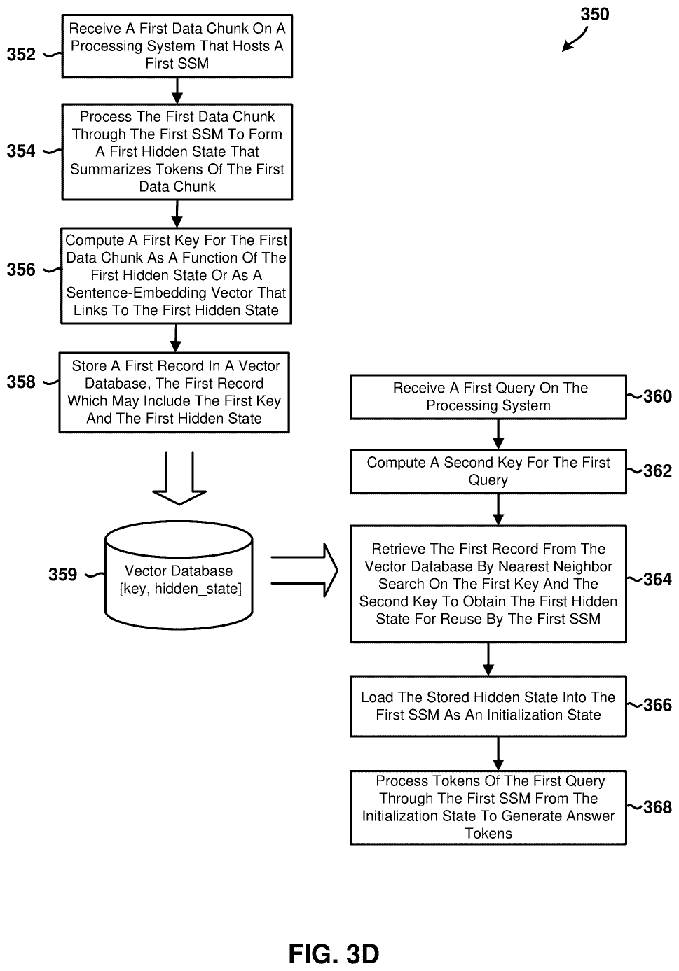

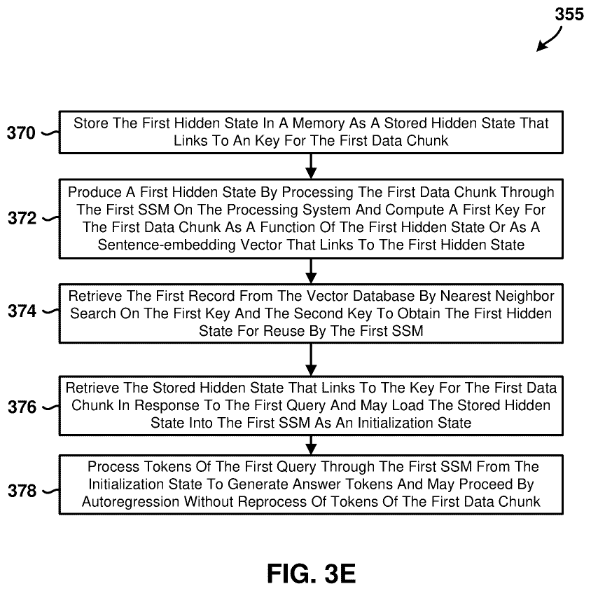

FIGS. 3A-3C illustrate a system that precomputes stored hidden states likely to be reused and stores compact representations. When a body of input exists, such as text blocks used in RAG, the system may precompute each block offline and save the corresponding stored hidden state.

The system may handle new and unknown tokens in real time by continuing from a stored hidden state. When a text block with a stored hidden state contributes to a new query, the system may load the hidden state of that block and continue processing the query from that state. This may avoid a second pass over the known text and may reduce memory access by processing the compact hidden state rather than a long token sequence.

Processing one token in a large language model (LLM) may involve multiplication of an embedding vector by large parameter matrices. On edge devices with limited memory, the system may access those parameters multiple times per token, and repetition may strain memory bandwidth. By precomputing and saving stored hidden states for RAG text blocks, the system may compute each block through the model once. This precomputation may occur offline on another system, such as server GPUs. The system may store the resulting stored hidden states in compact form and may load the state corresponding to a selected RAG text block when needed. Because a RAG text block may exceed the user query in length, this solution may reduce computation and memory access, speed responses, and lower power consumption.

The system illustrated in FIGS. 3A-3C may improve user experience on resource-constrained devices. For example, a device that processes five words per second may require about two minutes to process 600 words of retrieved context for one question. With precomputation, the system may process the retrieved context in advance, allowing the user to wait only for the processing of the question and the generation of the answer. A 15-word question may take about three seconds. This may apply to spoken or typed input because model processing may outpace speech or typing. Processing speed appears adequate if answer generation proceeds faster than the user is able to read or listen.

In some embodiments, the processing system or edge device may use a Temporal Event-Based Neural Network (TENNs) model, which has a particularly compact hidden state representation that may reduce processing power requirements and limit reliance on high-speed memory.

As discussed, in some embodiments, the device may store information as a tuple that includes a key (e.g., retrieval index vector) and a stored hidden state. In some embodiments, the tuple may use non-text numeric representation and may omit source tokens. The device may apply access control for the vector database. The device may apply optional encryption at rest such as AES-GCM with a hardware root of trust.

Some embodiments may apply to any LLM, as an example of an LXM, that processes context input tokens serially and benefits from precomputation of contextual information. SSMs may provide advantages, particularly the TENNs variant, an enhanced SSM. Such systems may include a compact internal state representation and may permit the processing system to store and manage data efficiently. TENNs may offer advantages for edge devices. The processing system may maintain a hidden state within a TENNs model that captures prior inputs. This hidden state may permit reuse of previously processed information without repeated resource-intensive operations and may yield faster and more efficient processing in resource-constrained environments.

Unlike other SSM variants and transformer architectures that maintain persistent states such as a key-value (KV) cache, a TENNs block has an internal state that takes the form of a one-dimensional vector with length equal to the model dimension. A Mamba hidden state may have shape (model_dim, coefficients), and a Mamba2 hidden state may have shape (heads, model_dim, coefficients). By contrast, a transformer block KV cache has shape (context length, model_dim). For SSMs such as TENNs and Mamba, the hidden-state dimensionality does not increase with context length, and the hidden state at any time represents the context processed up to that point. For transformers, the dimensionality of persistent states grows with context length and may be inefficient to maintain and update. For example, for a 2000-token context and 2048-dimensional embeddings at 32-bit precision, a TENNs hidden state may occupy about 8 KB, whereas a transformer KV cache for the same context may occupy about 16 MB for either the keys or values (and about 32 MB total when both are stored).

SSM networks are versatile and may take forms tailored for applications in audio, vision, and LLMs. An SSM may undergo training in a feedforward configuration and may later be converted to a recurrent configuration. To illustrate the advantages of SSMs generally, and TENNs specifically, over competing LLM architectures, a minimal TENNs network example may be described.

Below, we illustrate a typical SSM. In this model, the vector H̅ represents an internal hidden memory. The vector Ā, along with the vector H̅, combined with the element-wise operator “∘” advances the hidden state. The input vector U is transformed by the matrix B̅ which projects the input (an embedding vector in this case) into the hidden unit's space. Finally, the measurement matrix C̅ projects the hidden state to an output. This output, after passing through the nonlinearity F( ) forms the input to the next layer of the neural network.

$${\overline{H}}_{\{ i , t \}}^{\{ 2048 \times 1 \}} = {\overline{A}}_{i}^{\{ 2048 \times 1 \}} ∘ {\overline{H}}_{\{ i , t - 1 \}}^{\{ 2048 \times 1 \}} + {B}_{i}^{\{ 2048 \times 2048 \}} \cdot {U}_{\{ i , t - 1 \}}^{\{ 2048 \times 1 \}}$$

$${Y}_{i , t}^{2048 \times 1} = {\overline{C}}_{i}^{2048 \times 2048} \cdot {\overline{H}}_{i , t}^{2048 \times 1}$$

$${U}_{i + 1 , t}^{2048 \times 1} = F ( {Y}_{i , t}^{2048 \times 1} )$$

This formulation highlights the compactness of the hidden state and the efficient update rule characteristic of SSMs. The ability to advance the hidden state with fixed-dimension operations, regardless of sequence length, may allow TENNs to process long contexts on resource-constrained devices without the memory growth or repeated parameter loads that characterize transformer architectures.

The depth of the network may be arbitrary. As the input progresses through the layers of the network, it effectively sets the state of the H̅ vector to encode a memory of all the inputs U. The matrices H̅, Ā, and C̅ may include complex numbers/values. While the specific functions of these matrices are beyond the scope of this disclosure, it is important to note that after a long sequence of inputs U, the matrix H̅, may have been transformed.

In some embodiments, an SSM may be integrated into a RAG system tailored for edge devices. A conventional RAG system may include a vector database and token encoders and decoders. Upon receiving a query, the system encodes the request into a list of tokens, retrieves relevant text from the vector database, appends the retrieved text to the query, and processes the combined sequence with an LLM.

While RAG is presented as one use case, the embodiments may also be applied within other AI-based systems. In particular, the formation of the hidden state may serve as a short-term or long-term memory. Such memories may provide the basis for durable storage. Embedding these vectors in a sparse, high-dimensional space may reduce the risk of catastrophic forgetting in neural networks.

Some embodiments may include methods of query-time execution on an SSM. Such methods may include receiving a first data chunk on a processing system that hosts a first SSM, processing the first data chunk through the first SSM to form a first hidden state that summarizes tokens of the first data chunk, and storing the first hidden state in memory as a stored hidden state obtained through precomputation that links to a key for the first data chunk. The method may further include receiving a first query on the processing system, retrieving the stored hidden state that links to the key for the first data chunk in response to the first query, loading the stored hidden state into the first SSM as an initialization state, and processing tokens of the first query through the first SSM from the initialization state to generate answer tokens. In some embodiments, processing of the first data chunk may update a per-layer hidden state for each layer of the first SSM in sequence, and the stored hidden state may include a final per-layer hidden state. In some embodiments, the key may include a sentence embedding vector that links to the stored hidden state. In some embodiments, the processing system may be included in an edge device. In some embodiments, storing the first hidden state may include writing a tuple [key, hidden_state] to a vector database. In some embodiments, retrieval may search the vector database with an embedding of the first query to match the key. In some embodiments, loading the stored hidden state may include copying per-layer vectors into on-chip static random access memory (SRAM). In some embodiments, the generation of answer tokens may proceed by autoregression without reprocessing the tokens of the first data chunk.

FIG. 3D is a process flow diagram that illustrates an example method 350 of offline precog record creation and single-source query-time reuse on an SSM. Method 350 may be performed in a computing device by a processing system that includes an SoC 100 with one or more processors 120-132 and memory 136 described in this application. The applications processor 122 may coordinate record creation and storage in DDR4 or DDR5 memory. The NPU 126 or the DSP 130 may execute an SSM. This configuration aligns with the SoC and method frameworks in FIGS. 1 and 3A-3C and with the detailed description of query-time operations.

In block 352, a processor in the processing system may receive a first data chunk on a processing system that hosts a first SSM. For text this may be a document chunk. For example, the applications processor 122 may read a UTF-8 text segment from local storage and bound the segment to 256 or 512 tokens to match an offline precompute budget.

In block 354, a processor in the processing system may process the first data chunk through the first SSM to form a first hidden state that summarizes tokens of the first data chunk. For example, the NPU 126 may apply the SSM update per token per layer and advance a fixed-length hidden vector without growth in size as context length rises. This may yield a compact representation that a processor may reuse at query time.

In block 356, a processor in the processing system may compute a first key for the first data chunk as a function of the first hidden state or as a sentence-embedding vector that links to the first hidden state. For example, the processor may apply a linear projection to the hidden state to produce a 768-dimensional key or compute a 768-dimensional sentence-embedding vector with a sentence-transformer model and record a link from that vector to the hidden state. This may support text-based retrieval or self-index retrieval.

In block 358, a processor in the processing system may store a first record in a vector database 359. The first record may include the first key and the first hidden state. For example, the processor may write the tuple [key, hidden_state] to DDR4 or DDR5 SDRAM as two contiguous arrays and omit the source tokens. This may reduce bandwidth during updates.

In block 360, a processor in the processing system may receive a first query. For example, the DSP 130 may deliver text decoded from speech or the UI stack may deliver typed text and the applications processor 122 may pass the token list to an embedding or SSM front end.

In block 362, a processor in the processing system may compute a second key for the first query. For example, the processor may run a sentence-transformer to form a 768-dimensional vector or pass the query tokens through the SSM from a neutral initialization to form a query hidden state and project that state to form the second key.

In block 364, a processor in the processing system may retrieve the first record from the vector database 359 by nearest neighbor search on the first key and the second key to obtain the first hidden state for reuse by the first SSM. For example, the processor may compute cosine similarity between the second key and database vectors, select the top match, and read its hidden state payload.

In block 366, a processor in the processing system may load the stored hidden state into the first SSM as an initialization state. For example, the NPU 126 may copy per-layer vectors into on-chip static random-access memory or cache and may set layer registers before the first query token enters the pipeline. This may avoid parameter bursts tied to context replay and may suit systems that include DDR4 or DDR5 SDRAM on resource-constrained edge devices.

In block 368, a processor in the processing system may process tokens of the first query through the first SSM from the initialization state to generate answer tokens. These operations may correspond to the flows in FIG. 3C and to method blocks 616-620.

Some embodiments may include methods of compact storage and retrieval of model context. Such methods may include producing a first hidden state by processing a first data chunk through a first SSM on a processing system, computing a first key for the first data chunk as either (i) a sentence embedding vector that links to the first hidden state or (ii) a projection derived from the first hidden state, and storing a tuple [key, hidden_state] in a vector database. The method may further include receiving a first query on the processing system, computing a second key for the first query, and retrieving the tuple from the vector database by nearest neighbor search on the first key and the second key to obtain the first hidden state for reuse by the first SSM. In some embodiments, the projection may include a linear function, and in other embodiments the projection may include a multilayer perceptron with fixed parameters. In some embodiments, the vector database may store each tuple as a non-text representation that omits tokens of the first data chunk. In some embodiments, retrieval of the tuple may trigger loading of the first hidden state into the first SSM as an initialization state for generation. In some embodiments, the processing system may store the vector database in DRAM and may store an active hidden state in on-chip SRAM.

FIG. 3E illustrates a tuple-centric embodiment that stores and retrieves a tuple [key, hidden_state] for reuse on an SSM. Blocks 370-378 perform the same or similar operations as blocks 354-368. The FIG. 3E text presents explicit tuple storage in a vector database and nearest-neighbor retrieval for reuse of the stored hidden state.

In some embodiments, when the target corpus is known in advance the processing system may bypass similarity scoring and may select the tuple by its identifier. The processing system may read the stored hidden state for that identifier and may load it as the initialization state. The processing system may next process the user query as described above. The retrieval key remains stored with the tuple to support both direct selection and similarity search in a single database format.

In block 370, a processor in the processing system may store the first hidden state in memory as a stored hidden state obtained through precomputation that links to a key for the first data chunk. For example, the processor may persist final per-layer state vectors after the precompute pass and maintain a stable link to the key stored in the vector database.

In block 372, a processor in the processing system may produce a first hidden state by processing the first data chunk through the first SSM on the processing system and may compute a first key for the first data chunk as a function of the first hidden state or as a sentence-embedding vector that links to the first hidden state.

In block 374, a processor in the processing system may store a first record in a vector database. The record may include the first key and the first hidden state. The processor may also retrieve the record from the vector database by nearest neighbor search on the first key and the second key to obtain the first hidden state for reuse by the first SSM.

In block 376, a processor in the processing system may retrieve the stored hidden state that links to the key for the first data chunk in response to the first query and may load the stored hidden state into the first SSM as an initialization state. This may reduce dynamic memory traffic and may improve throughput on systems that use DDR4 or DDR5 SDRAM without HBM.

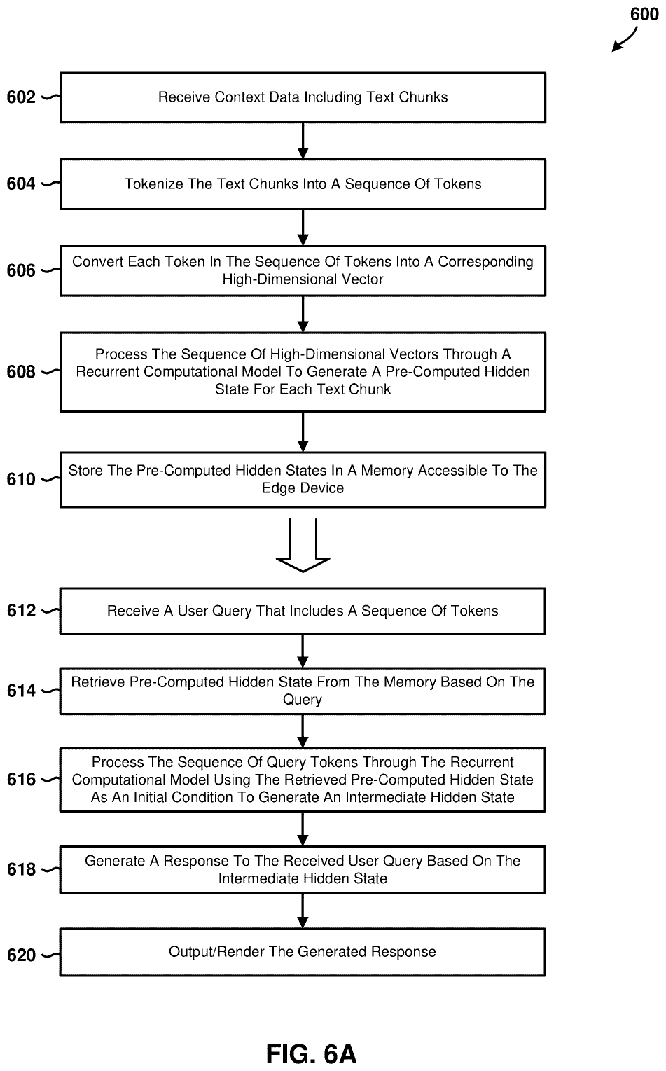

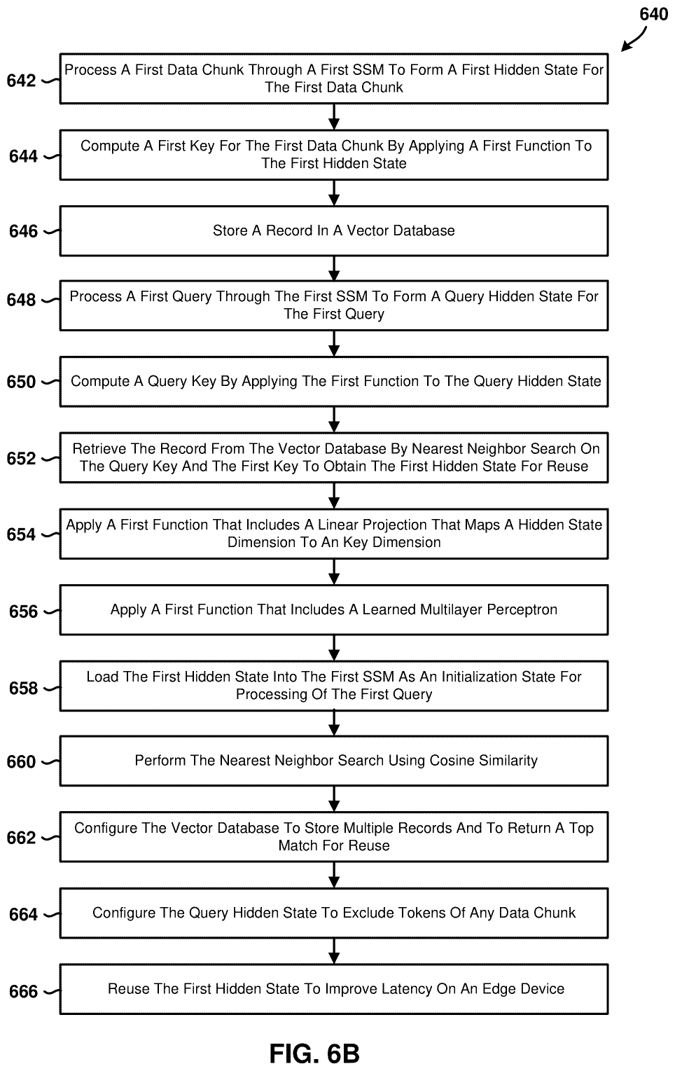

In block 378, a processor in the processing system may process tokens of the first query through the first SSM from the initialization state to generate answer tokens and may proceed by autoregression without reprocessing tokens of the first data chunk. These operations may correspond to the operations described with reference to FIGS. 3C and 6.

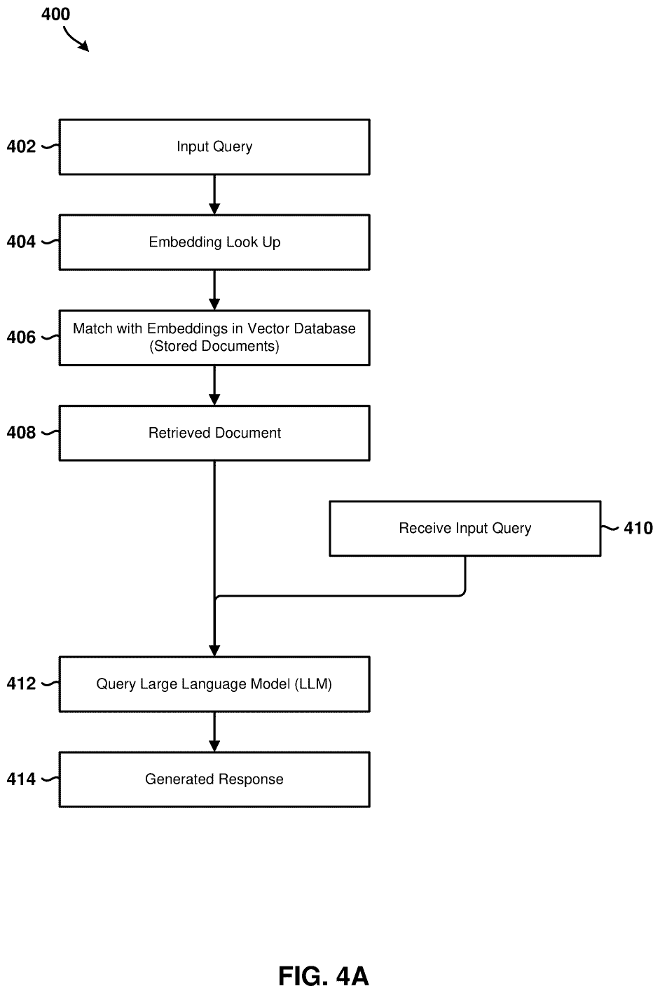

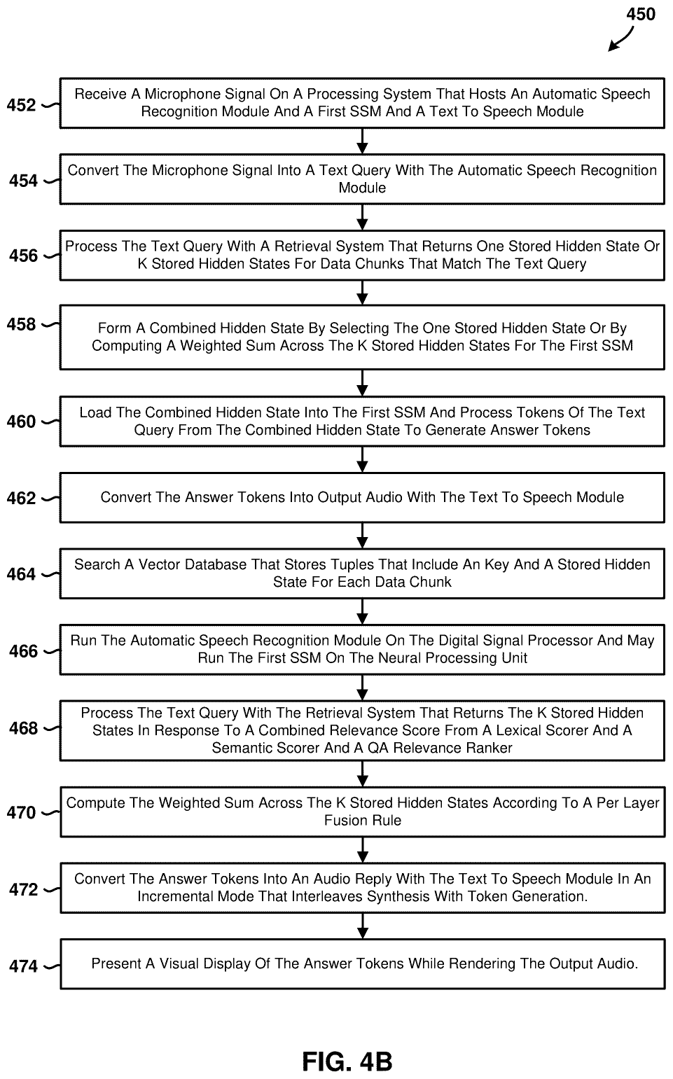

FIG. 4A is a process flow diagram illustrating an example method 400 in a RAG system for edge devices in accordance with some embodiments. Method 400 may be performed in a computing device by a processing system that includes one or more processors, such as processors 120-132 and related components or subsystems described in this application.

In block 402, the processing system may receive an input query in the form of a text string that includes a sequence of words or subwords. For example, the system may receive a user-provided question or command through a user interface such as a text entry field or a voice-to-text input system. This operation may improve usability on edge devices by supporting flexible input modes without reliance on cloud infrastructure.

In block 404, the processing system may transform the text string into a list of numerical vectors. Each word, subword, or portion of the query may be converted into a real-valued or complex-valued vector, producing a list of vectors. The system may apply a linear or nonlinear function to the list to generate a single embedding vector that summarizes the query. For example, the system may generate this embedding by applying a sentence embedding model or by summing the vectors of the individual tokens. This operation may provide a compact representation of the query that may reduce memory access and may prepare the query for efficient matching against stored vectors.

In block 406, the processing system may match the embedding vector against vectors stored in a vector database. The embedding may take the form of a sentence embedding or another representation, and in some embodiments the list of token vectors may be processed using an SSM, with the resulting hidden vector used as the representation. The system may match the hidden vector against vectors derived from stored data chunks. Matching may be performed using cosine similarity or other distance measures, including quasi-metrics that provide practical comparisons. For example, the system may compute cosine similarity between the input embedding and stored embeddings to identify the closest match. By using embeddings and similarity search, the system may reduce bandwidth compared to transmitting entire documents and may reduce latency by localizing search to compact vectors.

In block 408, the processing system may retrieve a relevant document or data chunk based on the matching process. For example, the system may retrieve a paragraph or section from the vector database that matches the query embedding. In some embodiments, the system may retrieve a stored hidden state that corresponds to a matched data chunk and may use that stored hidden state for initialization. This operation may avoid reprocessing large volumes of data by narrowing retrieval to compact and relevant material, which may improve runtime efficiency on edge devices with limited memory.

In block 410, the processing system may receive a follow-up query related to the retrieved content. For example, the system may receive a second question from the user that requests clarification or additional detail regarding the retrieved document. By permitting iterative queries, the system may reuse a stored hidden state or an intermediate hidden state and may avoid recomputing earlier context, which may reduce repeated computation and may improve responsiveness.

In block 412, the processing system may query the LLM using the user query together with the retrieved document or with the retrieved stored hidden state. For example, the system may construct context information from the retrieved content, combine it with the input query, and provide both to the LLM for processing. This operation may provide the LLM with context-aware input and may reduce redundant processing, which may lower memory access demand and may improve throughput on edge devices.

In block 414, the processing system may receive a response generated by the LLM. For example, the system may receive an answer or explanation that addresses the user's query, where the response is generated using both the input query and the retrieved document as context or using the input query with a retrieved stored hidden state. This operation may provide real-time answers to user queries and may reduce reliance on cloud resources. The method may improve device functionality by lowering power consumption, reducing latency, and delivering responsive query handling on resource-constrained hardware.

Method 400 may improve the operation of a computing device by reducing memory traffic, lowering computational demand, and decreasing latency during query-time operations. By transforming queries into compact embeddings, matching them against stored vectors, retrieving relevant document segments or stored hidden states, and processing those inputs with an LLM in conjunction with the query, the system may avoid redundant computation and large-scale memory transfers that would otherwise burden resource-constrained hardware. These operations may collectively improve device functionality by delivering responsive, context-aware answers in real time, reducing power consumption, and extending the practical use of LLMs to edge devices without reliance on high-speed memory or cloud resources.

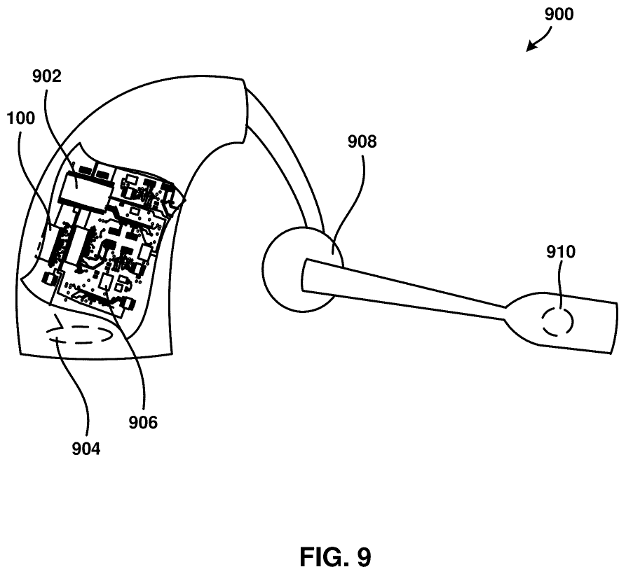

FIG. 4B is a process flow diagram illustrating an example method 450 of voice interaction on an edge device with precog retrieval and an SSM in accordance with some embodiments. Method 450 may be performed in a computing device, such as headset 900 in FIG. 9, by a processing system that includes an SoC 100 with processors 120-132 and memory 136 described in this application. For example, the DSP 130 may execute an automatic speech recognition (ASR) module, the NPU 126 may execute a first SSM, the applications processor 122 may orchestrate retrieval and user interface tasks, and the DSP 130 or the applications processor 122 may execute a text-to-speech module.

In block 452, a processor in the processing system may receive a microphone signal on a system that hosts an ASR module, a first SSM, and a text-to-speech module. For example, the DSP 130 may sample 16-bit pulse-code modulation (PCM) at 16 kHz, segment audio into 20 ms frames, apply pre-emphasis, and forward frames to an acoustic front end while the SoC 100 maintains buffer pointers for the ASR module, the first SSM, and the text-to-speech module

In block 454, a processor in the processing system may convert the microphone signal into a text query with the ASR module. For example, the DSP 130 may compute 80-channel log-Mel features per frame, may pass features to a transducer decoder, may emit Unicode text or subword tokens, and may deliver a text query to the applications processor 122 with timestamps for alignment.

In block 456, a processor in the processing system may process the text query with a retrieval system that returns one stored hidden state obtained through precomputation or k stored hidden states obtained through precomputation for data chunks that match the text query. For example, the applications processor 122 may compute a 768-dimensional sentence embedding vector of the text query or may form a query hidden state with the first SSM and project it, may search a vector database in DDR4 or DDR5 SDRAM by cosine similarity, and may return one stored hidden state obtained through precomputation or k stored hidden states obtained through precomputation that link to matched chunks.

In block 458, a processor in the processing system may form a combined hidden state by selecting the one stored hidden state obtained through precomputation or by computing a weighted sum across the k stored hidden states obtained through precomputation for the first SSM.

In block 460, a processor in the processing system may load the combined hidden state into the first SSM and may process tokens of the text query from the combined hidden state to generate answer tokens. For example, the NPU 126 may copy one vector per-layer into on-chip SRAM, may set recurrent registers, and may run autoregression on the text query tokens while a sampler on the applications processor 122 selects next tokens.

In block 462, a processor in the processing system may convert the answer tokens into output audio with the text-to-speech module. For example, the DSP 130 may map tokens to phonemes, may synthesize a Mel spectrogram with a small acoustic model, and may run a neural vocoder to produce 22.05 kHz audio that streams to a speaker.

In block 464, a processor in the processing system may search a vector database that stores tuples that include a key and a stored hidden state obtained through precomputation for each data chunk. For example, the applications processor 122 may store each tuple as [key, hidden_state], where the key is a 768-dimensional sentence embedding or a projection of a hidden state, and where both arrays reside contiguously in DDR4 or DDR5 SDRAM for fast direct memory access (DMA) into the NPU 126.

In block 466, a processor in the processing system may run the ASR module on the digital signal processor and may run the first SSM on an NPU. For example, the DSP 130 may execute the ASR decoder with fixed-point kernels and the NPU 126 may execute the first SSM with FP16 tensors while the applications processor 122 maintains control flow and memory maps across modules.

In block 468, a processor in the processing system may compute a combined relevance score from a lexical scorer and a semantic scorer and a QA relevance ranker. Examples may include BM25 and cosine similarity and a cross-encoder. In some embodiments, the processing system may process the text query with the retrieval system that returns the k stored hidden states obtained through precomputation in response to a combined relevance score from a lexical scorer and a semantic scorer and a cross-encoder.

In block 470, a processor in the processing system may compute the weighted sum across the k stored hidden states obtained through precomputation according to a per-layer fusion rule.

In block 472, a processor in the processing system may convert the answer tokens into an audio reply with the text-to-speech module in an incremental mode that interleaves synthesis with token generation. For example, the applications processor 122 may pass each token to the DSP 130 on arrival, the DSP 130 may emit audio frames per token boundary, and the audio driver may queue 40-60 ms buffers to keep latency low during speech.

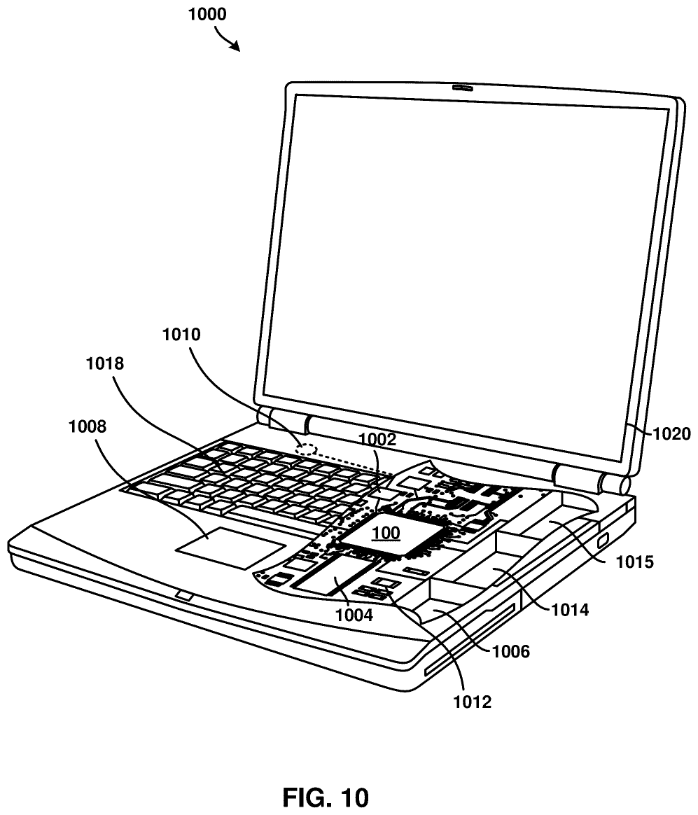

In block 474, a processor in the processing system may present a visual display of the answer tokens while rendering the output audio. For example, the applications processor 122 may stream partial text to a display on the headset 900 or laptop display 1020 illustrated and described with reference to FIG. 10 and may keep the text cursor in sync with audio timestamps supplied by the DSP 130.

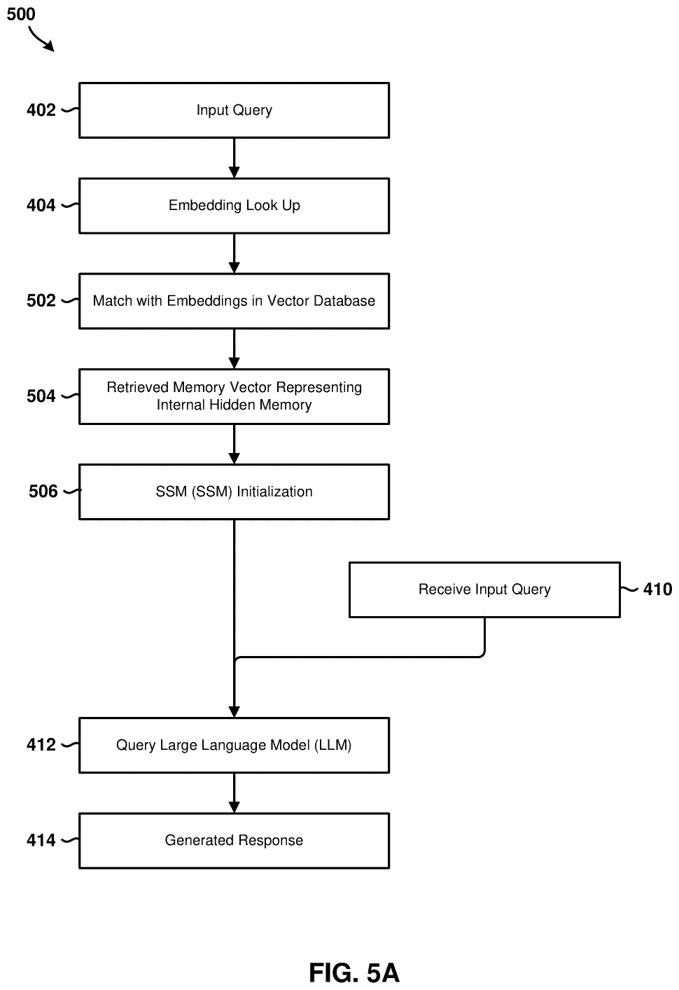

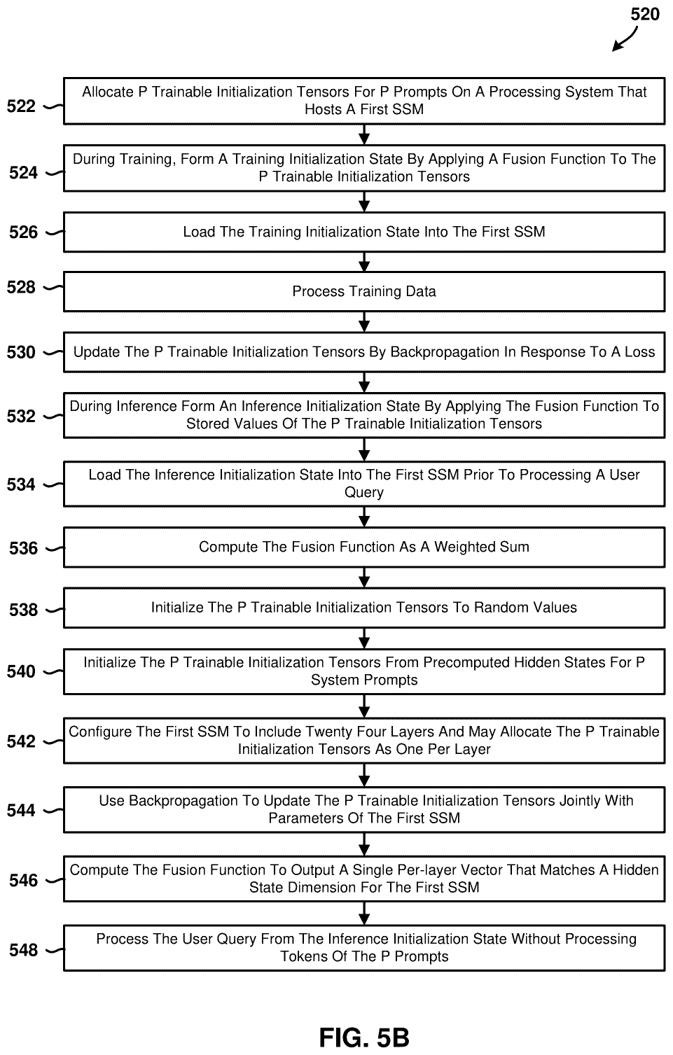

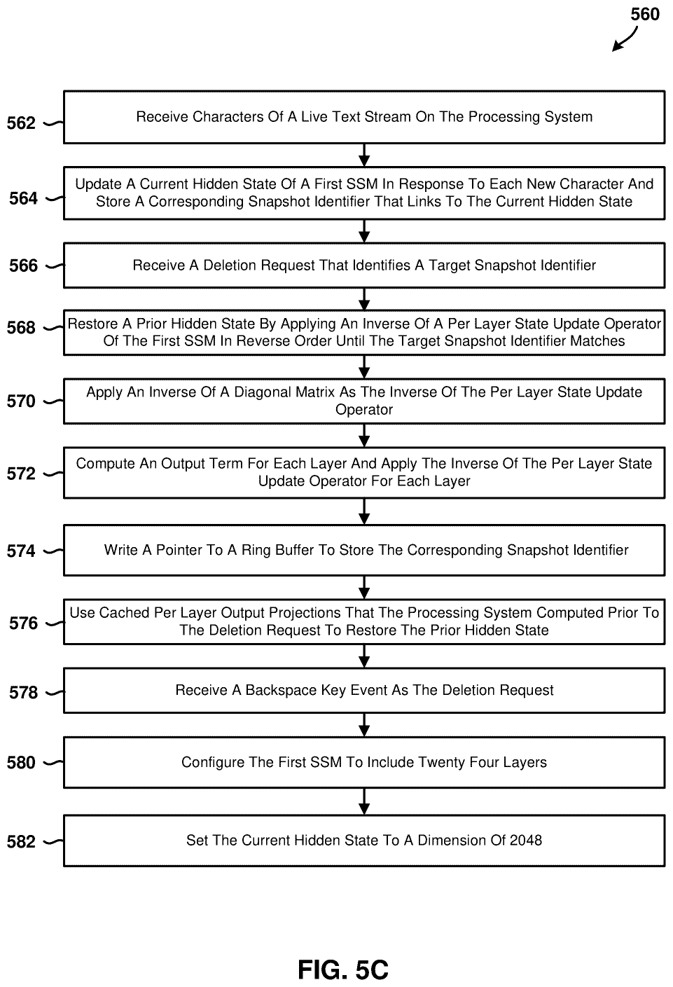

FIG. 5A is a process flow diagram illustrating an example precognition method 500 for edge devices in accordance with some embodiments. Method 500 may be performed in a computing device by a processing system that includes one or more processors such as processors 120-132 and related components or subsystems described in this application. In blocks 402 and 406, the processing system may perform the operations in like-numbered blocks 402 and 404 described with reference to FIG. 4.

In block 502, the processing system may match the embedding vector derived from the input query against stored hidden state obtained through precomputations stored in a vector database. Unlike block 406, which matches query embeddings against stored document embeddings or raw text, block 502 operates on compact stored hidden state obtained through precomputations. These hidden states encapsulate information extracted from source documents and may remove the need to reprocess or retrieve entire documents. A hidden state may also include additional context such as appliance-specific knowledge or troubleshooting operations. The system may perform matching using cosine similarity or other quasi-metric methods that support efficient retrieval without heavy memory use or computation.

In block 504, the processing system may retrieve a stored hidden state obtained through precomputation H that represents the internal memory of the model. This hidden state may include contextual data or background knowledge that enhances understanding of the current task. For example, H may include common knowledge about the operations of household appliances that goes beyond what is included in user manuals. The background knowledge embedded in H may be acquired by fine-tuning the LLM on external datasets or pre-training the system with broader domain knowledge. This fine-tuning may allow the LLM to provide robust and more informed responses during real-time interactions.

In block 506, the processing system may initialize the SSM. Initialization may include an initialization vector that primes the model with baseline context, the input query, and a task-specific prompt. The prompt may instruct the LLM how to interpret the query and how to structure its response so that the output aligns with the desired style and task requirements.

In blocks 410-414, the processing system may perform the operations in like-numbered blocks 410-414 illustrated and described with reference to FIG. 4.

In some embodiments, the processing system may be configured to operate an SSM in a forward mode. Consider a network with two layers of SSMs and a new input U that updates the network as follows:

$${H}_{1}^{′} = {A}_{1} {H}_{1} + {B}_{1} U$$

$${Y}_{1}^{′} = {f}_{1} ( U , {C}_{1} {H}_{1}^{′} ) ,$$

$${H}_{2}^{′} = {A}_{2} {H}_{2} + {B}_{2} {Y}_{1}^{′}$$

$${Y}_{2}^{′} = {f}_{2} ( {Y}_{1} , {C}_{2} {H}_{2} )$$

The subscript denotes the layer of the network. Here, ƒ denotes an arbitrary nonlinear activation function. A typical realization of ƒ could be: f(U,CH)=SiLU(u+LayerNorm(CH)) where we have a residual block with layer normalization.

In some embodiments, the processing system may be configured to operate an SSM in a reverse mode to revert hidden states. Assume that A₁ is an invertible matrix (e.g., a diagonal matrix of full rank). To revert the effects of U on the hidden states, one may exchange the order of output projection with the hidden state update, then invert the hidden state update as follows:

$${Y}_{1}^{′} = f ( U , {C}_{1} {H}_{1}^{′} )$$

$${H}_{1} = {A}_{1}^{- 1} {H}_{1}^{′} - {A}_{1}^{- 1} {B}_{1} U$$

$${Y}_{2}^{′} = {f}_{2} ( {Y}_{1}^{′} , {C}_{2} {H}_{2}^{′} )$$

$${H}_{2} = {A}_{2}^{- 1} {H}_{2}^{′} - {A}_{2}^{- 1} {B}_{2} {Y}_{1}^{′}$$

In this process, the output Y′ for each layer must be computed first before reversing the hidden state.

In some embodiments, the processing system may be configured to perform parallel processing during rollback. If the function ƒ operates solely on CH (without residual connections), then in reverse mode, the output projection operations may be performed first for all layers in parallel. Specifically:

$${Y}_{1}^{′} = f ( {C}_{1} {H}_{1}^{′} )$$

$${Y}_{2}^{′} = {f}_{2} ( {C}_{2} {H}_{2}^{′} )$$

and so forth. The outputs y′ may then be cached temporarily and used to revert the hidden states, again in parallel:

$${H}_{1} = {A}_{1}^{- 1} {H}_{1}^{′} - {A}_{1}^{- 1} {B}_{1} U ,$$

$${H}_{2} = {A}_{2}^{- 1} {H}_{2}^{′} - {A}_{2}^{- 1} {B}_{2} {Y}_{1}^{′} ,$$

and so forth. This time-reversal solution may allow the processing system to efficiently roll back hidden states, improve handling of user edits in real-time, and reduce computational overhead on resource-constrained edge devices.

The precog process provides several technical advantages. Each document may create a memory trace once, rather than requiring repeated token-by-token reprocessing. This reduces runtime load and makes on-device inference practical for power-, compute-, and memory-constrained hardware. An SSM with precog may process fewer than 20 tokens per second during the generative phase and still deliver timely responses, compared to conventional models that often require more than 1000 tokens per second. The relationship between multiply-accumulate operations and model parameters allows efficient scaling. A one-billion-parameter SSM at 20 tokens per second may budget, for example, 20 to 80 GFLOPs per second. The range may depend on kernel structure, weight reuse, count of multiply-accumulate operations per token, or other similar factors.

The precog process may also support real-time text entry. As the user types, the system may update the hidden state incrementally and store snapshots. If the user deletes input, the system may restore the prior hidden state instead of recomputing the entire sequence. When the user completes input, the system has already processed most tokens and may return a response with minimal delay. This reduces latency and provides real-time feedback.

These capabilities extend to scenarios such as situational awareness in unidirectional communications, where compact hidden states may be broadcast instead of entire datasets. Field clients may query the precomputed states locally, gaining timely and precise answers without two-way connectivity. The approach also supports low-cost consumer and industrial devices. For example, appliances or printers may embed an LLM with precog-stored manuals or FAQs, providing interactive guidance without reliance on cloud services and operating for the device's lifetime without backend support.

Method 500 may improve computer functionality by reducing runtime computation, lowering latency, and decreasing power use. By processing context once and reusing compact hidden states, the method supports responsive real-time performance on devices with constrained resources and extends practical deployment of LLMs to edge environments.

FIG. 5B is a process flow diagram illustrating an example method 520 of training and inference on an SSM in accordance with some embodiments. Method 520 may be performed in a computing device by a processing system that includes one or more processors, such as processors 120-132 and related components or subsystems described in this application. For example, the applications processor 122 may orchestrate data movement and control flow, the NPU 126 may execute the first SSM, and the DSP 130 may handle tokenization or audio I/O where applicable.

In block 522, a processor in the processing system may allocate P trainable initialization tensors for P prompts on a processing system that hosts a first state-space model. For example, the applications processor 122 may reserve a region in memory 136 for P prompt tensors and may create an index so the NPU reads one prompt tensor per-layer without extra copies.

In block 524, a processor in the processing system may, during training, form a training initialization state by applying a fusion function to the P trainable initialization tensors. For example, the applications processor 122 may call a fusion routine that combines the P prompt tensors per-layer into one per-layer vector so the model starts each batch with a consistent state.

In block 526, a processor in the processing system may load the training initialization state into the first state-space model. For example, the runtime may write the per-layer vectors into on-chip state slots before tokens enter the model so each layer begins from the fused prompt state.

In block 528, a processor in the processing system may process training data. For example, the trainer may stream token sequences from storage to the NPU in batches while the applications processor 122 monitors loss values and manages checkpoints.

In block 530, a processor in the processing system may update the P trainable initialization tensors by backpropagation in response to a loss. For example, the trainer may adjust prompt tensor values after each batch and may log the deltas so later analysis verifies stability.

In block 532, a processor in the processing system may, during inference, form an inference initialization state by applying the fusion function to stored values of the P trainable initialization tensors. For example, the applications processor 122 may read the trained tensors from nonvolatile storage and may run the same fusion routine to produce the per-layer start state for the session.

In block 534, a processor in the processing system may load the inference initialization state into the first state-space model prior to processing a user query. For example, the runtime may write one vector per-layer into on-chip SRAM on the NPU and may start token processing from that fused state with no prompt tokens added at runtime.

In block 536, a processor in the processing system may compute the fusion function as a weighted sum. For example, the applications processor 122 may apply a stored list of weights to the prompt tensors and may aggregate per-layer so the output fits the layer state format without extra conversion.

In block 538, a processor in the processing system may initialize the P trainable initialization tensors to random values. For example, the trainer may seed a generator and may fill each prompt tensor with small values, which may allow the model to explore useful starting conditions during fine-tuning.

In block 540, a processor in the processing system may initialize the P trainable initialization tensors from a stored hidden state obtained through precomputation for P system prompts. For example, an offline job may run each system prompt once through the same model, may capture the final hidden states, and may store those states as the initial prompt tensors before training.

In block 542, a processor in the processing system may configure the first state-space model to include twenty-four layers and may allocate the P trainable initialization tensors as one per-layer. For example, the applications processor 122 may set the layer count in a configuration file and may create one prompt tensor per-layer so the load path stays simple and fast.

In block 544, a processor in the processing system may use backpropagation to update the P trainable initialization tensors jointly with parameters of the first state-space model. For example, the trainer may keep two learning-rate schedules so prompt tensors and model weights adapt together or in phases under the same optimization step.

In block 546, a processor in the processing system may compute the fusion function to output a single per-layer vector that matches the hidden state dimension for the first state-space model. For example, the fusion routine may return one vector per-layer so the NPU writes it directly to the layer state slot without reshaping.

In block 548, a processor in the processing system may process the user query from the inference initialization state without processing tokens of the P prompts. For example, the runtime may accept user tokens from a text field or a voice front end and may start generation from the fused state so the device avoids prompt token overhead.

FIG. 5C is a process flow diagram that illustrates an example method 560 of low-latency text entry on an SSM in accordance with some embodiments. Method 560 may be performed in a computing device by a processing system that includes an SoC 100 with processors 120-132 and memory 136 described in this application.

In block 562, a processor in the processing system may receive characters of a live text stream on the processing system. For example, the applications processor may read keyboard events from a keyboard or a touch UI and may enqueue one character at a time into a shared buffer for an NPU thread.

In block 564, a processor in the processing system may update the current hidden state of a first SSM in response to each new character and store a corresponding snapshot identifier that links to the current hidden state. For example, the NPU runtime may advance per-layer hidden vectors after each character and may push a snapshot identifier into a small circular index that points to the matching state location.

In block 566, a processor in the processing system may receive a deletion request that identifies a target snapshot identifier. For example, the UI service may package a backspace event with the last emitted snapshot identifier and may post that message to the model thread.

In block 568, a processor in the processing system may restore a prior hidden state by applying an inverse of a per-layer state update operator of the first SSM in reverse order until the target snapshot identifier matches. For example, the model thread may traverse layers from top to bottom and may apply precomputed inverse update operators to rewind the hidden vectors to the state that matches the target identifier.

In block 570, a processor in the processing system may apply an inverse of a diagonal matrix as the inverse of the per-layer state update operator. For example, the loader may store per-layer diagonal values and may compute element-wise reciprocals during initialization so the rollback path uses multiply operations with no matrix solver.

In block 572, a processor in the processing system may compute an output term for each layer and next apply the inverse of the per-layer state update operator for each layer. For example, the runtime may read cached layer outputs produced before the deletion and may next apply the inverse operator to update the hidden vectors in reverse layer order.

In block 574, a processor in the processing system may write a pointer to a ring buffer to store the corresponding snapshot identifier. For example, a snapshot module may advance a head index modulo a fixed length and may store the identifier and a pointer into SRAM that marks the state location.

In block 576, a processor in the processing system may use cached per-layer output projections that the processing system computed prior to the deletion request to restore the prior hidden state. For example, the model thread may fetch the saved projections from on-chip SRAM and may avoid recompute while it applies inverse updates.

In block 578, a processor in the processing system may receive a backspace key event as the deletion request. For example, the UI driver may map a single backspace press to the most recent snapshot identifier from the ring buffer and may forward that identifier to the NPU.

In block 580, a processor in the processing system may configure the first SSM to include twenty-four layers. For example, the inference graph may define twenty-four recurrent layers and may allocate one hidden vector per-layer in SRAM.

In block 582, a processor in the processing system may set the current hidden state to a dimension of 2048. For example, the state descriptor may declare 2048 elements per-layer and may store those elements in FP16 format to limit memory bandwidth on the edge device.

In some embodiments, the hidden state may use one vector per layer. With a 2048-element state at FP16, the size may be 4 KB per layer. With 24 layers, the per-model state may be 96 KB. A transformer KV cache for 2000 tokens and 2048-dimensional FP16 vectors may be about 8 MB for keys or 8 MB for values or 16 MB in total.

In some embodiments, the processing system may pre-read a known corpus such as a book or a manual and may store one stored hidden state that summarizes the corpus. The processing system may process tokens of the corpus through the state-space model once to produce a final per-layer state. The processing system may compute a retrieval index vector for the corpus by a sentence-embedding model or by a projection of the hidden state. The processing system may store a tuple that includes an identifier for the corpus, the retrieval index vector, and the stored hidden state in a vector database located in dynamic random-access memory. The processing system may omit storage of source tokens. The processing system may protect the tuple by access control and, where used, encryption at rest. The tuple uses non-text numeric representation.

During query-time operation the processing system may receive a user query and a selection of a corpus identifier. The processing system may retrieve the tuple by the identifier and may load the stored hidden state into on-chip static random-access memory by direct memory access, one vector per layer of the state-space model. The processing system may process the query tokens from that initialization state and may generate answer tokens. The processing system may present the answer on a display or as audio by the text-to-speech module already described for the voice loop. The processing system may switch to a different corpus by loading the stored hidden state of another tuple. The processing system may complete the switch by DMA with no replay of the corpus.

When the processing system needs information from more than one corpus the processing system may retrieve multiple stored hidden states and may form a combined hidden state by a fusion function. The fusion function may compute a weighted sum per layer or may use a learned mapper per layer as already described for multi-source fusion. The fused state may serve as the initialization state for the same query-time path.

FIG. 6A is a process flow diagram illustrating a more detailed method 600 of executing an LLM on the edge device in accordance with some embodiments. With reference to FIGS. 1-6, method 600 may be performed by a processing system that includes one or more components or subsystems described in this application, such as processors 120-132 of the SoC 100. The operations in method 600 may be executed by a processing system configured with software or firmware to perform some or all of the operations. To cover the range of configurations described, the term “processing system” refers to hardware capable of executing the method.

In block 602, the processing system may receive context data that includes text chunks. For example, the processing system may retrieve the context data from a local memory, a remote database, or from real-time user inputs. In some embodiments, the context data may be preloaded into the memory of the edge device, such as preprocessed documents, user history, or application-specific information. The context data may also come from external sources, such as connected cloud servers, APIs, or sensor inputs. For example, in an autonomous vehicle system, the context data may include navigation maps, sensor data, and traffic reports, all provided in chunks for efficient processing.

In block 604, the processing system may tokenize the text chunks into a sequence of tokens. For example, the processing system may divide the text chunks into smaller, discrete units such as words, subwords, or characters, as discussed.

In block 606, the processing system may convert each token in the sequence of tokens into a corresponding high dimensional vector. For example, the processing system may use an embedding layer within a neural network architecture to transform each token into a dense vector representation. As discussed, the embedding layer may map discrete tokens to continuous high dimensional vectors so that each vector captures semantic information about the token based on its usage and relationships to other tokens.

In block 608, the processing system may process the sequence of high dimensional vectors through a recurrent computational model to generate a stored hidden state obtained through precomputation for each text chunk. The stored hidden state obtained through precomputation may include a compact representation of all tokens processed up to that point/token.

In some embodiments, the recurrent computational model may be an SSM. In some embodiments, the SSM may be a TENNs.

In some embodiments, processing the sequence of high dimensional vectors in block 608 may include updating a fixed-length hidden state vector for each token in the sequence of tokens. The fixed-length hidden state vector may maintain a constant dimensionality during the processing of each token.

In some embodiments, the processing system may be configured to pre-process the context data and store stored hidden state obtained through precomputations in the memory for later retrieval during real-time query processing. For example, the processing system may analyze large volumes of context data in advance to generate and store the corresponding stored hidden state obtained through precomputations. Such preprocessing may reduce the need for the system to perform complex calculations at the time of a query. When a real-time query is received, the processing system may simply retrieve the relevant stored hidden state obtained through precomputation directly from memory.

In block 610, the processing system may store the stored hidden state obtained through precomputations in a memory accessible to the edge device. The stored hidden state obtained through precomputations may be stored in the memory in a compressed format that reduces the data size while retaining sufficient information to represent the corresponding text chunk. In some embodiments, the stored hidden state obtained through precomputation may be stored in a high-performance or standard-performance static or non-volatile or volatile memory (e.g., DDR4/DDR5 SDRAM) of the edge device. In some embodiments, the stored hidden state obtained through precomputation may include information that allows for the processing of query tokens without requiring reprocessing of the corresponding text chunk. In some embodiments, the processing system may be configured to store the weights of the SSM in volatile memory (e.g., DDR4/DDR5 SDRAM) and store the stored hidden state obtained through precomputations in non-volatile or static memory.

The stored hidden state obtained through precomputation may encapsulate the contextual representation of the processed text chunk, acting as a snapshot of the model's understanding at that point. By storing this intermediate state, the system may load the hidden state from memory and continue processing without re-analyzing the text in real-time. This allows for efficient retrieval and integration with new input, such as user queries, and reduces computational overhead for the edge device when generating responses.

In block 612, the processing system may receive a user query that includes a sequence of query tokens. For example, the processing system may obtain input from a user through a user interface, such as a text-based input interface or a speech recognition system. The processing system may then process the input to break down the user's query into individual tokens that may be used in conjunction with the stored hidden state obtained through precomputations to generate a response to the query in real-time or near real-time.

In block 614, the processing system may retrieve a stored hidden state obtained through precomputation from memory based on context data relevant to the received user query. For example, the processing system may use a statistical retrieval method or a relevance model to evaluate the content of the query tokens and determine which stored hidden state obtained through precomputation most closely aligns with the context of the query. This may include comparing the query tokens to stored context data, identifying relevant matches, and selecting the corresponding hidden state that encapsulates the most appropriate contextual information.

In some embodiments, retrieving the stored hidden state obtained through precomputation from the memory in block 614 may include determining the relevant context for the user query using a statistical retrieval method based on the content of the query tokens and selecting the stored hidden state obtained through precomputation corresponding to the determined context. For example, the processing system may analyze the query tokens and compare them to representations of the stored hidden state obtained through precomputations stored in memory to identify the hidden state that best matches the context of the query based on the content of the tokens. The selected most relevant hidden state may be used as the starting point for processing the new query.

In block 616, the processing system may process the sequence of query tokens through the recurrent computational model using the retrieved stored hidden state obtained through precomputation as an initial condition to generate an intermediate hidden state. For example, the processor may load the stored hidden state obtained through precomputation into memory and use it as a starting point for evaluating the query tokens. As each query token is processed, the recurrent computational model may update the intermediate hidden state based on the information contained in the token and the pre-existing context from the precomputed state. This allows the system to efficiently handle new input without reprocessing the entire context.

In block 618, the processing system may generate a response to the received user query based on the intermediate hidden state. For example, the processing system may use the intermediate hidden state as the foundation for producing a series of output tokens that collectively form the response.

In some embodiments, generating the response in block 618 may include creating a sequence of response tokens. The processing system may generate the initial response token based on the intermediate hidden state and an initial token. The processing system may generate each subsequent token based on its preceding token and the intermediate hidden state. The processing system may repeatedly perform these operations until the full sequence of tokens is assembled, compiled, and/or used to generate the output.

In block 620, the processing system may output/render the generated response, such as by sending the generated response to an output interface of the edge device for display or audio output.

In some embodiments, the processing system may implement functionality to combine multiple stored hidden state obtained through precomputations from different information sources.

In some embodiments, the processing system may implement a single-source retrieval component by selecting one information source from the knowledge base, loading the associated stored hidden state obtained through precomputation, and initializing the SSM with that hidden state. This operation may improve memory efficiency compared to transformer architectures, but it may encounter limitations when queries require information from multiple sources.

When the processing system implements single-source retrieval, computing one token through an LLM may involve multiplying the embedding-dimension vector by all parameters in the network. Because network connections are dense, the processing system may load the complete parameter set for each token. Edge devices often lack memory capacity to store the parameters in full, so the processing system may reload them for every token. With billions of parameters, this repeated reloading may create a throughput bottleneck.

When the processing system processes queries that require synthesis of information from multiple sources, single-source retrieval may present architectural constraints that limit performance.

In some embodiments, the processing system may retrieve and use one hidden state from the most relevant chunk, but it may not generate a complete response when the query depends on multiple chunks. Real-world queries often require synthesis across several sections of documents or across different knowledge sources. For example, when the processing system processes a query about troubleshooting refrigerator temperature issues, it may need to combine information from chunks that address temperature settings, diagnostic procedures, and maintenance requirements. A single-chunk approach may force users to submit multiple sequential queries or accept incomplete responses.

When the processing system processes queries that require comparison, correlation, or analysis across multiple sources, single-source retrieval may produce incomplete responses. For example, when the processing system processes a query such as “Compare energy efficiency settings across different operating modes” or “What are the safety considerations when using multiple appliance features simultaneously,” a response derived from one chunk may not provide complete context.

When the processing system operates in single-chunk retrieval mode, it may generate responses that are technically correct but contextually incomplete because they exclude information from other sources. This limitation may result in partial answers that may mislead a user or require additional queries to obtain complete context.

In some embodiments, the processing system may implement a multi-source hidden state fusion system to overcome the limitations of single-source retrieval. The processing system may combine multiple stored hidden state obtained through precomputations from different information sources in a precog-enabled configuration. By doing so, the processing system may generate multi-source responses while maintaining computational and memory efficiency suitable for edge deployment.

In some embodiments, the processing system may extend single-source retrieval by implementing a multi-source hidden state fusion system that preserves efficiency while supporting synthesis across multiple sources. The processing system may precompute hidden states for information sources associated with a document and may store those hidden states for later retrieval. The processing system may process each block of known text through the LLM network once, including offline processing on a server-class processor such as a GPU. The processing system may then save each stored hidden state obtained through precomputation in compact form and may load the hidden state only when needed. When needed, the processing system may load the hidden state for the selected RAG chunk rather than the entire document. Because RAG chunks are typically larger than the user query, this approach may reduce compute and memory operations, accelerate response time, and reduce power consumption.

In some embodiments, the processing system may implement the multi-source hidden state fusion system by applying a mathematical fusion algorithm at the hidden state level. The processing system may combine multiple precomputed contextual representations without reprocessing the original information sources. The multi-source system may include multiple stages, such as multi-source retrieval, relevance scoring, and hidden state fusion.

In some embodiments, the processing system may implement a multi-source hidden state fusion system that processes queries requiring synthesis across multiple sources. Instead of retrieving one hidden state, the processing system may retrieve multiple hidden states based on query-source relevance metrics. The processing system may combine the retrieved hidden states using mathematical fusion techniques to create a unified starting state for the SSM. From this unified state, the processing system may process the query and may generate a response that synthesizes information across multiple sources.

In some embodiments, the processing system may implement the combination of multiple stored hidden state obtained through precomputations, each associated with a different information source, through a hidden state fusion algorithm. The algorithm may combine the hidden states using configurable mathematical operations that preserve SSM properties. The processing system may further implement query-adaptive multi-retrieval with intelligent source selection to determine the number of hidden states to combine based on query characteristics. The processing system may also implement an edge-optimized architecture that supports memory-efficient processing by combining hidden states without simultaneously loading all sources.

In some embodiments, the processing system may retrieve multiple information sources based on query-chunk relevance scores. The processing system may calculate the relevance scores using keyword matching, semantic similarity from a vector search, and question-answer relationship evaluation. After retrieval, the processing system may combine the associated stored hidden state obtained through precomputations through weighted averaging.

In some embodiments, the processing system may compute the fused hidden state according to the following formula:

$$Combined\_Hidden \_State = \sum ( weight\_i \times hidden\_state \_i ) ,$$

In some embodiments, the processing system may dynamically calculate the weights based on query chunk relevance scores. The processing system may further implement query adaptive k selection to determine the number of chunks to retrieve and combine based on query complexity metrics. The processing system may also implement a memory efficient streaming combination by processing the hidden states sequentially or in small batches to reduce memory footprint during fusion.

In some embodiments, the processing system may implement the combination of multiple stored hidden state obtained through precomputations, each associated with a different information source, as a multi-stage retrieval and fusion process. The multi-stage system may extend the precog architecture described above to process multiple information sources in parallel.

In some embodiments, the processing system may extend the precog architecture by implementing a multi-source hidden state fusion system that maintains computational efficiency while supporting multi-source synthesis. The processing system may execute a mathematical fusion algorithm at the hidden state level, combining multiple precomputed contextual representations without reprocessing the original information sources. The system architecture may include multiple processing stages such as multi-source retrieval, relevance scoring, and layer-wise hidden state fusion.

In some embodiments, the processing system may implement the combination of multiple stored hidden state obtained through precomputations, each associated with a different information source, as a multi-stage retrieval and fusion process. This process may extend the precog architecture described above so that the processing system handles multiple information sources at the same time.

In some embodiments, the processing system may extend the precog architecture by implementing a multi-source hidden state fusion system that preserves computational efficiency while supporting synthesis of information from multiple sources. In these embodiments, the processing system may apply a mathematical fusion algorithm at the hidden state level. The algorithm may combine multiple precomputed contextual representations without reprocessing the original information sources. The processing system may implement the multi-source fusion system through multiple stages that include multi-source retrieval, relevance scoring, and layer-wise hidden state fusion. Further details of these stages are described below.

In some embodiments, the processing system may implement a multi-source retrieval phase. The processing system may process a user query through one or more encoding models to generate a query representation in a high-dimensional space. The processing system may perform retrieval operations using indexing methods and similarity metrics to identify the top-k relevant sources. The value of k may be determined based on configurable criteria such as query characteristics, available resources, or application requirements. Each retrieved source may include an associated stored hidden state obtained through precomputation generated during precog processing and stored in a format compatible with the model architecture.

In some embodiments, the processing system may implement a relevance scoring process. The processing system may combine outputs of multiple scoring mechanisms using a configurable weighting scheme. The processing system may apply lexical matching algorithms to measure exact term relevance, may apply neural re-ranking models to evaluate semantic relationships, and may apply vector similarity measures such as cosine similarity to evaluate semantic closeness. The processing system may adjust the weighting of these scoring methods in a configurable manner to balance different relevance criteria. By combining multiple metrics rather than a single metric, the processing system may improve accuracy of source selection.

In some embodiments, the processing system may implement a layer-wise hidden state fusion process. The processing system may apply a mathematical combination algorithm that preserves the mathematical properties of the SSM while supporting synthesis of information from multiple sources. The processing system may combine hidden state representations from multiple sources using relevance-based weighting schemes. The processing system may apply consistent fusion parameters across layers so that dimensional consistency is maintained throughout the network. The processing system may perform the fusion independently at each model layer, which may allow the SSM to preserve mathematical integrity while synthesizing information across multiple sources.

FIG. 6B is a process flow diagram illustrating an example method 640 of self-index retrieval on a SSM in accordance with some embodiments. Method 640 may be performed in a computing device by a processing system that includes an SoC 100 with processors 120-132 and memory 136 described in this application. For example, the applications processor may schedule memory traffic, the NPU may run the first SSM, and memory 136 may store records and active states. FIG. 1 in the drawings shows SoC 100 and labels processors 120-132 and memory 136, and the detailed description defines keys and record storage for hidden states.

In block 642, a processor in the processing system may process a first data chunk through a first SSM to form a first hidden state for the first data chunk. For example, the applications processor may stream tokens of the first data chunk to the NPU, and the NPU may update per-layer vectors until the final per-layer hidden state is ready for storage.

In block 644, a processor in the processing system may compute a first key for the first data chunk by applying a first function to the first hidden state. For example, a projection head on the NPU may read the first hidden state and may emit a smaller vector that a retrieval system indexes in memory.

In block 646, a processor in the processing system may store a record in a vector database, the record which may include the first key and the first hidden state. For example, the controller may write a [key, hidden_state] pair into a RAM-resident index and may persist the hidden state in device memory that supports fast reads.

In block 648, a processor in the processing system may process a first query through the first SSM to form a query hidden state for the first query. For example, the runtime may accept query tokens from a user interface and may advance the model from a zero or prompt-derived start to produce the query hidden state.

In block 650, a processor in the processing system may compute a query key by applying the first function to the query hidden state. For example, the same projection head may transform the query hidden state into a vector that the retrieval system uses as a search key.

In block 652, a processor in the processing system may retrieve the record from the vector database by nearest neighbor search on the query key and the first key to obtain the first hidden state for reuse. For example, the retrieval system may compute similarities between the query key and stored keys and may return the record that matches best so that the hidden state is ready for reuse.

In block 654, a processor in the processing system may apply a first function that includes a linear projection that maps a hidden state dimension to an key dimension. For example, a single fully connected layer on the NPU may multiply the hidden state by a weight array to emit the key with reduced length that suits the database.

In block 656, a processor in the processing system may apply a first function that includes a learned multilayer perceptron. For example, the controller may call an MLP head with two dense layers and a nonlinearity to form the key from the hidden state, and the training stack may tune that head offline.

In block 658, a processor in the processing system may load the first hidden state into the first SSM as an initialization state for processing of the first query. For example, the runtime may copy one per-layer vector into on-chip SRAM for each layer and may start token processing from that loaded state. The drawings and text describe direct state load on SoC 100 for query-time execution.

In block 660, a processor in the processing system may perform the nearest neighbor search using cosine similarity. For example, the retrieval code may normalize vectors and may compute a similarity score that the system uses to rank candidates before returning the match.

In block 662, a processor in the processing system may configure the vector database to store multiple records and to return a top match for reuse. For example, the database may maintain an inverted-file or flat index over many pairs and may return the highest-scoring pair as the match.

In block 664, a processor in the processing system may configure the query hidden state to exclude tokens of any data chunk. For example, the controller may run the model over user tokens without appending context tokens so that the query key reflects the live query only.

In block 666, a processor in the processing system may reuse the first hidden state to improve latency on an edge device. For example, the system may skip reprocessing of the first data chunk and may start generation from the reused state so that DRAM and NPU traffic stays low on SoC 100.

In some embodiments, the processing system may combine multiple stored hidden states from different sources by a fusion function that outputs one combined hidden state. The fusion function may target SSM layers that admit linear or piecewise-linear state update. When the SSM includes nonlinear gates or normalization the device may apply a learned mapper that adapts the fused state before generation. The mapper may accept relevance weights and source states and may output one per-layer vector per model layer. The device may run the mapper once per query before token processing. Fusion weights may sum to one after normalization per query.

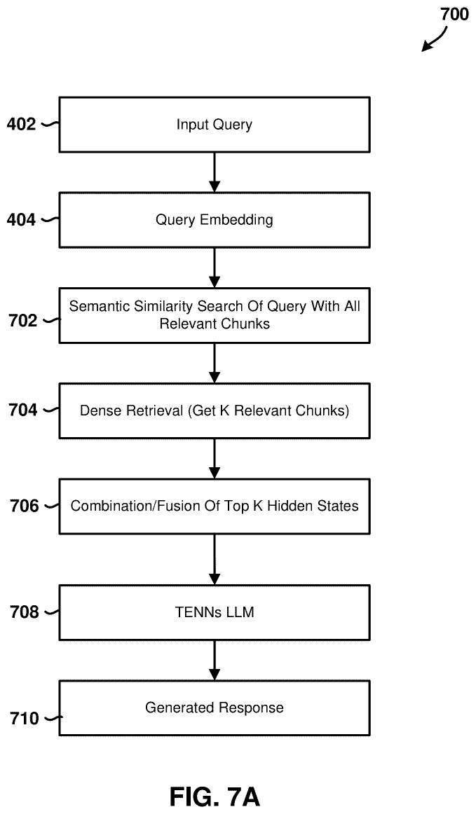

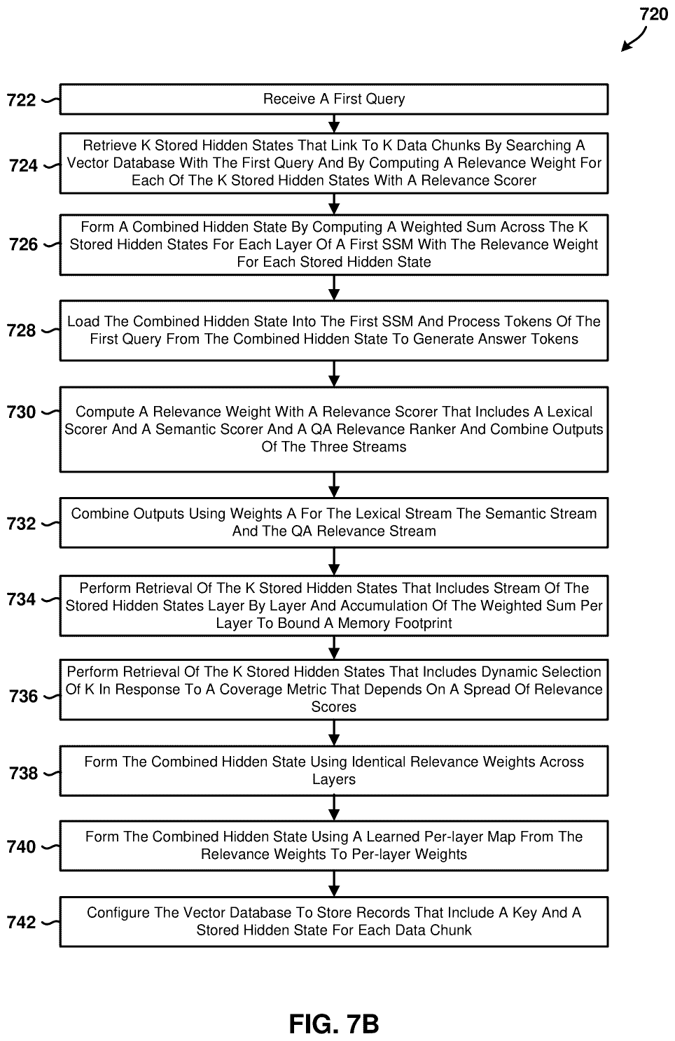

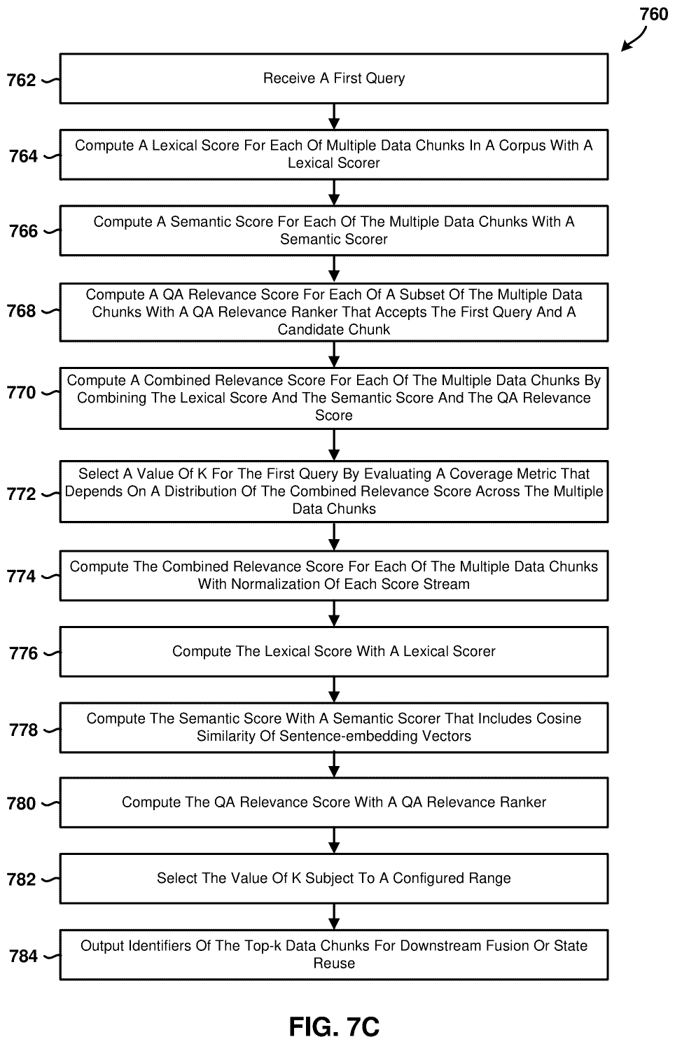

FIG. 7A is a process flow diagram illustrating an example precognition method 700 for edge devices configured to implement a multi-source hidden state fusion system. Method 700 may be performed in a computing device by a processing system that includes one or more processors, such as processors 120-132 and related components or subsystems described in this application. In blocks 402 and 406, the processing system may perform the operations described in the like-numbered blocks of FIG. 4A. In some embodiments, the processing system may encode the query using a sentence-transformer embedding model to generate a 768-dimensional query vector.

In block 702, the processing system may conduct a semantic similarity search between the query vector and a set of stored chunks. The processing system may retrieve multiple information sources based on query-chunk relevance scores. The processing system may calculate the scores using keyword matching, semantic similarity from a vector search, and question-answer relationship evaluation.

In block 704, the processing system may combine outputs from three methods. A lexical method for keyword matching. A semantic method for vector similarity. A QA relevance ranking method for query-answer assessment. Examples may include BM25 for the lexical method and cosine similarity for the semantic method and a cross-encoder as a QA relevance ranker.

In some embodiments, the processing system may perform dense retrieval to obtain k relevant chunks. In some embodiments, the processing system may execute a vector database search to retrieve the top-k sources based on cosine similarity. In one implementation, the processing system may combine outputs from three scoring methods: BM25Plus (30 percent weighting) for keyword relevance, a cross-encoder neural model (45 percent weighting) for question-answer assessment, and cosine similarity (25 percent weighting) for semantic similarity.

In block 706, the processing system may combine the top-k hidden states associated with the retrieved chunks. In some embodiments, the processing system may implement a layer-wise fusion to combine the hidden states.

In block 708, the processing system may process the fused hidden state with a TENNs LLM. In some embodiments, the processing system may apply identical weights derived from the relevance scores to each of the 24 TENNs layers. The processing system may implement the fusion by applying the weighted sum formula at each layer: Combined_Hidden_State[layer]=Σ(weight_i×hidden_state_i[layer]).

In block 710, the processing system may receive a query response generated by the TENNs LLM based on the combined hidden state.

Method 700 improves operation of the processing system by allowing comprehensive multi-source query handling while preserving efficiency on edge devices. By retrieving multiple relevant hidden states, weighting them with adaptive relevance scores, and applying layer-wise fusion within a TENNs LLM, the processing system may generate responses that reflect broader context than single-source retrieval. This may reduce redundant token processing, lower memory footprint, and decrease power use compared to transformer architectures, while delivering contextually complete answers in real-time on resource-constrained hardware.

FIG. 7B is a process flow diagram illustrating an example method 720 of multi-source context on a SSM in accordance with some embodiments. Method 720 may be performed in a computing device by a processing system that includes one or more processors, such as processors 120-132 and related components or subsystems described in this application.

In block 722, a processor in the processing system may receive a first query on the processing system. For example, the applications processor may accept a spoken or typed question and may pass a normalized string to an embedding or indexer that prepares retrieval inputs without cloud dependency.

In block 724, a processor in the processing system may retrieve k stored hidden state obtained through precomputations that link to k data chunks by searching a vector database with the first query and by computing a relevance weight for each of the k stored hidden state obtained through precomputations with a relevance scorer. For example, the CPU may search a RAM-resident vector database for keys and may fetch [key, hidden_state] tuples that correspond to the top candidates while the relevance model computes weights for those candidates.

In block 726, a processor in the processing system may form a combined hidden state by computing a weighted sum across the k stored hidden state obtained through precomputations for each layer of a first state space model with the relevance weight for each stored hidden state obtained through precomputation. For example, the NPU may iterate layer by layer and may accumulate a weighted sum per-layer to build a per-layer combined vector that preserves the SSM layer structure. The drawings include pseudocode on page 10 that illustrates per-layer fusion across multiple source states.

In block 728, a processor in the processing system may load the combined hidden state into the first state space model and process tokens of the first query from the combined hidden state to generate answer tokens. For example, the runtime may copy one vector per-layer into on-chip SRAM and may advance the SSM through the query tokens so that generation proceeds from the fused starting state without reprocessing document tokens.

In block 730, a processor in the processing system may compute a relevance weight with a relevance scorer that includes a lexical scorer and a semantic scorer and a QA relevance ranker. The device may combine outputs of the three streams to form one weight per chunk. Examples may include BM25 for the lexical scorer and cosine similarity for the semantic scorer and a cross-encoder as a QA relevance ranker.

In block 732, a processor in the processing system may combine outputs using configured coefficients for the lexical stream and the semantic stream and the QA relevance stream.

In block 734, a processor in the processing system may perform retrieval of the k stored hidden state obtained through precomputations that includes stream of the stored hidden state obtained through precomputations layer by layer and accumulation of the weighted sum per-layer to bound a memory footprint. For example, the database thread may read layer 0 from each selected record, the fusion kernel may accumulate layer 0, and the system may free buffers before proceeding to layer 1 so that DRAM usage remains low on SoC 100.

In block 736, a processor in the processing system may perform retrieval of the k stored hidden state obtained through precomputations that includes dynamic selection of k in response to a coverage metric that depends on a spread of relevance scores. For example, the controller may start with a minimum k and may increase k while the score distribution indicates missing coverage across topics until the coverage metric crosses a threshold. In some embodiments, coverage metric may equal the entropy of the normalized relevance distribution across retrieved chunks with a threshold τ.

In block 738, a processor in the processing system may form the combined hidden state using identical relevance weights across layers. For example, the runtime may compute one set of chunk weights from the scorer outputs and may apply that set unchanged at each SSM layer so that fusion remains simple and fast.

In block 740, a processor in the processing system may form the combined hidden state using a learned per-layer map from the relevance weights to per-layer weights. For example, a small per-layer mapper may accept global chunk weights and may output layer-specific weights that adjust emphasis for deeper-layers to improve answer quality on-device.

In block 742, a processor in the processing system may configure the vector database to store records that include an key and a stored hidden state obtained through precomputation for each data chunk.

FIG. 7C is a process flow diagram illustrating an example method 760 of query-adaptive multi-stage retrieval with dynamic k in accordance with some embodiments. Method 760 may be performed in a computing device by a processing system that includes one or more processors, such as processors 120-132 and related components or subsystems described in this application.

In block 762, a processor in the processing system may receive a first query on the processing system. For example, the applications processor may accept a text or voice query and may normalize case and punctuation, and the processor may pass a token sequence to a query encoder that prepares vectors for retrieval on-device.

In block 764, a processor in the processing system may compute a lexical score for each of multiple data chunks in a corpus with a lexical scorer. For example, the CPU may build a sparse inverted index over chunk terms and may compute BM25Plus scores across the corpus to produce a lexical score per chunk.

In block 766, a processor in the processing system may compute a semantic score for each of the multiple data chunks with a semantic scorer. For example, the CPU or NPU may generate a sentence-embedding vector for the query and may compute cosine similarity against stored keys that link to chunks to produce a semantic score per chunk.

In block 768, a processor in the processing system may compute a QA relevance score for each of a subset of the multiple data chunks with a QA relevance ranker that accepts the first query and a candidate chunk. An example ranker may include a cross-encoder neural re-ranker.

In block 770, a processor in the processing system may compute a combined relevance score for each of the multiple data chunks by combining the lexical score and the semantic score and the QA relevance score.

In block 772, a processor in the processing system may select a value of k for the first query by evaluating a coverage metric that depends on a distribution of the combined relevance score across the multiple data chunks. For example, the controller may compute the spread of the combined scores, may assess whether the scores cluster or spread across topics, and may increase or decrease k until the coverage metric crosses a threshold.

In block 774, a processor in the processing system may normalize each score stream to a common range and may apply configured weights to form the combined relevance score. Example streams may include a lexical scorer such as BM25 and a semantic scorer such as cosine similarity and a QA relevance ranker such as a cross-encoder.

In block 776, a processor in the processing system may compute the lexical score with a lexical scorer, which may include BM25Plus. For example, the retrieval module may maintain per-field term statistics and may compute BM25Plus for title and body fields of each chunk to improve lexical recall on the device.

In block 778, a processor in the processing system may compute the semantic score with a semantic scorer that includes cosine similarity of sentence-embedding vectors. For example, the system may store one key per chunk in a RAM-resident vector database and may compute cosine similarity between the query vector and each stored key.

In block 780, a processor in the processing system may compute the QA relevance score with a QA relevance ranker. An example ranker may include a cross-encoder neural re-ranker.

In block 782, a processor in the processing system may select the value of k subject to a configured range. For example, the controller may clamp k to a device profile such as 2 through 8 on a handset and 4 through 16 on a laptop so that downstream fusion and memory use stay within budget.

In block 784, a processor in the processing system may output identifiers of the top-k data chunks for downstream fusion or state reuse. For example, the retrieval module may return chunk identifiers or direct pointers to stored [key, hidden_state] tuples so that the next stage loads hidden states without reprocessing tokens.

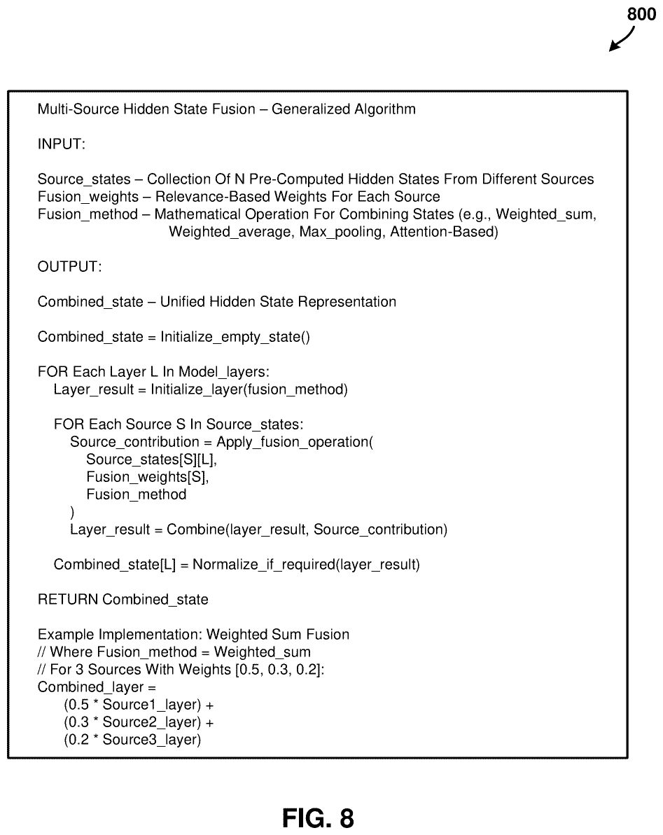

FIG. 8 is an image illustrating pseudocode 800 that the processing system may perform or implement to support a RAG system configured with multiple information sources on an edge device. In some embodiments, the pseudocode 800 may direct the processing system to combine multiple stored hidden state obtained through precomputations, each hidden state corresponding to a different information source, to generate a response to a user query based on multiple sources.

For example, the pseudocode 800 may cause the processing system to generate a unified hidden state representation by, for example, initializing a combined hidden state as an empty state structure configured to store a representation for each layer of a model, selecting a layer from among a plurality of layers of the model and initializing a temporary layer result based on a selected fusion method (which may include a weighted sum, a weighted average, a pooling operation, and/or an attention-based operation), determining a source contribution for the selected layer of a selected source from among a plurality of sources of pre-computed hidden states (the source contribution being determined by applying a fusion operation to a hidden state of the selected source at the selected layer using a relevance-based weight associated with the selected source and the selected fusion method), combining the source contribution with the temporary layer result to generate an updated layer result, repeating the determining and combining for each of the plurality of sources to generate a final layer result for the selected layer, normalizing the final layer result when the selected fusion method requires normalization, and storing the normalized result in the combined hidden state as the representation for the selected layer. The processing system may repeat the selecting, determining, combining, and normalizing operations for each layer of the plurality of layers to populate the combined hidden state. The processing system may output the combined hidden state as the unified hidden state representation that integrates contributions from the plurality of sources in accordance with the selected fusion method and associated weights.

In some embodiments, the processing system may apply the pseudocode 800 to implement the multi-source hidden state fusion operations described with reference to method 700 of FIG. 7A. The pseudocode may direct the processing system to retrieve stored hidden state obtained through precomputations, apply fusion weights, and perform layer-wise fusion operations to construct a unified hidden state that serves as the starting state for an SSM.

In some embodiments, the processing system may execute the pseudocode 800 as part of the system described herein to carry out multi-source retrieval, relevance scoring, and hidden state fusion. The pseudocode illustrates how the processing system may compute a combined hidden state by iterating through layers, applying source-specific contributions, and normalizing results when required. The combined hidden state may then be used by the processing system to process queries with an LLM such as a TENNs model.

In some embodiments, the processing system may implement a multi-source hidden state fusion system configured to execute a RAG process that uses multiple information sources as described herein. When the processing system retrieves information that has already been precomputed into hidden states, the system may reduce the time required to generate responses. The user may then wait only for the query tokens to be processed and for the response tokens to be generated.

For example, the processing system may process a fifteen-word query in approximately three seconds. This response time may be substantially shorter than the time required for a system that does not rely on stored hidden state obtained through precomputations, where processing may extend into tens of seconds or longer. As such, the processing system may therefore provide response times that remain below the threshold of user perception.

In some embodiments, the processing system may process tokens faster than a user may enter them through speech or typed text. As a result, the user may not perceive delay during input (i.e., there is no user-perceivable delay). Similarly, the processing system may generate response tokens faster than a user is able to read or listen to them, which may provide a seamless user experience. In this configuration, processing wait times may be negligible from the perspective of the user, even on edge devices with constrained resources.

In some implementations, the multi-source systems and methods described herein, configured to combine multiple different information sources, may be specifically adapted to the proprietary TENNs SSM systems, creating synergistic advantages unavailable to systems using standard transformers. In some embodiments, the systems thus configured may open new use cases, employments, and/or markets in healthcare, legal, engineering, and scientific applications requiring comprehensive information analysis.

In some embodiments, the processing system may implement a multi-source hidden state fusion system that combines information from multiple sources while preserving the efficiency advantages of precog processing. When the processing system executes a TENNs model, the system may maintain a memory footprint on the order of 8 KB per hidden state, compared to approximately 8 MB for transformer architectures. This 1000-fold reduction in memory size may be preserved even when the processing system combines hidden states from multiple sources. The compact representation may allow the processing system to store and retrieve hidden states using standard memory such as DDR4 or DDR5 SDRAM, rather than relying on high-speed memory components. By doing so, the processing system may support deployment on cost-effective edge devices while maintaining offline operation and delivering performance suited for enterprise-grade applications.

In some embodiments, the processing system may implement a configurable multi-stage scoring process when combining multiple stored hidden state obtained through precomputations. The processing system may calculate relevance scores using methods such as cross-encoder evaluation, cosine similarity, and BM25Plus. In some implementations, the processing system may apply domain-specific optimization or expert-defined weight configurations to achieve performance tailored to the application. The processing system may also monitor weight assignments to avoid incorrect allocation of weights across hidden states. Incorrect weight assignment may lead the processing system to select irrelevant or contradictory chunks, which may result in generation of responses that appear confident but are factually incorrect.

In some embodiments, the processing system may execute a generation model that requires specialized training to process fused hidden states. The training may prepare the generation model to combine information from multiple hidden states and to generate responses that attribute and balance content from different information sources. Standard training of language models often focuses on single-context generation, which may not prepare the processing system to operate effectively in multi-source contexts created through hidden state fusion. Without specialized training, the generation model may not be adequate to handle complex multi-source information environments, and the processing system may not generate coherent responses that correctly integrate information from multiple sources.

In some embodiments, the processing system may implement a multi-source method for executing an LLM on an edge device with multi-chunk information fusion. The processing system may operate an SSM to maintain multiple stored hidden state obtained through precomputations that store information from different sources in compact form. The processing system may precompute input contexts from multiple text sources for the LLM, a process referred to as multi-chunk precognition or multi-chunk precog. The processing system may store the precomputed contexts as compact hidden state representations prior to runtime and may combine them mathematically during runtime without reprocessing the original sources.

In some embodiments, the processing system may receive an input query and may process the query by retrieving multiple relevant stored hidden state obtained through precomputations. The processing system may combine the retrieved hidden states using weighted fusion to create a unified contextual representation. This operation may reduce the demand for intensive burst computation and high-speed memory while supporting synthesis of information across multiple sources.

In some embodiments, the processing system may generate a response based on the combined input query and the fused hidden states. The generative phase may require generation of a relatively small number of tokens while incorporating information from multiple sources. By limiting runtime token processing and relying on stored hidden state obtained through precomputations, the processing system may reduce computational demand on the edge device and may deliver multi-source responses efficiently.

In some embodiments, the processing system may implement a multi-source system for deploying an LLM with multi-chunk fusion capabilities on an edge device. The edge device may include a microprocessor unit (MPU), a central processing unit (CPU), and optionally an accelerator such as a digital signal processor (DSP), a small graphics processing unit (GPU), or a neural processing unit (NPU). The edge device may also include memory components that provide cost-effective standard-performance storage for multiple stored hidden state obtained through precomputations, each hidden state corresponding to a different information source.

In some embodiments, the processing system may operate an SSM that retains multiple hidden states representing information from different sources processed during previous network exposures. The processing system may also implement a mechanism for precomputing multiple input contexts, referred to as multi-chunk precognition or multi-chunk precog. The processing system may store these precomputed contexts in compact hidden state form and may combine them mathematically at runtime without reprocessing the original information sources.

In some embodiments, the processing system may implement a RAG process. The processing system may encode a client query into tokens, retrieve multiple relevant hidden states from a vector database using a multi-stage scoring process, and combine the retrieved hidden states through weighted fusion. The fused hidden state may then be processed by the LLM to generate a response that reflects information from multiple sources.

In some embodiments, a non-transitory computer-readable medium may store A non-transitory processor-readable storage medium having stored thereon data and configurations to control a state machine or cause a processor to perform various operations for implementing a method for multi-chunk LLM processing on an edge device. The method may include maintaining multiple stored hidden state obtained through precomputations within an SSM, where the hidden states compactly store information from different sources processed during previous network exposures.

In some embodiments, the method may further include precomputing and storing multiple input contexts for the LLM, referred to as multi-chunk precognition or multi-chunk precog. The precomputed contexts may be available for mathematical combination during runtime without requiring reprocessing of the original sources or additional computational resources.

In some embodiments, the method may further include encoding a received query into a list of tokens and retrieving multiple relevant stored hidden state obtained through precomputations from a vector database. The retrieval may use multi-stage scoring that combines semantic similarity, contextual relationship analysis, and keyword-based matching. The processing system may then combine the retrieved hidden states using weighted fusion based on query-specific relevance scores.

In some embodiments, the method may further include processing the fused hidden state with the LLM to reduce reliance on high-speed memory and to minimize burst computation during runtime. By applying multi-source fusion, the processing system may synthesize information from multiple sources efficiently on an edge device.

In some embodiments, the method may further include generating a response based on the fused hidden state and the query. The generative phase may require the creation of a relatively small number of tokens while incorporating information from multiple precomputed contexts. This approach may lower the computational load on the edge device and may provide contextually complete responses across multiple sources.

In some embodiments, the processing system may implement a method for executing an LLM on an edge device by representing multi-source system prompts with multiple initial hidden states of a recurrent network. The initial hidden states may be tuned during training so that multiple task-specific system prompts from different sources may prime the recurrent network for downstream tasks that require synthesis of information across multiple sources.

In some embodiments, the processing system may configure the recurrent network to ingest multiple system prompts and to produce multiple hidden states that represent the different contextual sources. During inference, the processing system may initialize the recurrent network with multiple precomputed internal states that are combined through weighted fusion, without re-ingesting the system prompts.

In some embodiments, the processing system may configure the initial hidden states to remain trainable during a fine-tuning stage for multi-source downstream tasks. The fusion weights may be optimized end-to-end so that the processing system improves the effectiveness of multi-source information synthesis.

In some embodiments, the processing system may initialize the internal states from multiple random vectors or zero vectors. During training, the processing system may adapt these initial vectors to learn multi-source representations without explicitly constructing multi-source system prompts.

In some embodiments, the processing system may implement a method for executing an LLM on an edge device with multi-chunk information fusion. The processing system may operate an SSM to maintain multiple stored hidden state obtained through precomputations that compactly store information from different sources processed during previous network exposures.

In some embodiments, the processing system may precompute input contexts from multiple text sources for the LLM, referred to as multi-chunk precognition or multi-chunk precog. The processing system may store the precomputed contexts as compact hidden state representations before runtime and may combine them mathematically during runtime without reprocessing the original sources.

In some embodiments, the processing system may receive an input query and may process the query by retrieving multiple relevant hidden states. The processing system may combine the retrieved hidden states using weighted fusion to construct a unified contextual representation. This operation may reduce the demand for burst computation and high-speed memory while supporting synthesis of information from multiple sources.

In some embodiments, the processing system may generate a response based on the combined input query and the fused hidden states. The generative phase may require the creation of a relatively small number of tokens while incorporating information from multiple sources. By limiting runtime token processing and reusing stored hidden state obtained through precomputations, the processing system may reduce computational load on the edge device.

In some embodiments, the processing system may store multiple associated keys derived by transformation of the original information sources into compressed vector forms. In some cases, the processing system may generate the keys by computing sentence embeddings for each chunk.

In some embodiments, the processing system may implement a multi-stage scoring process for retrieval. The processing system may combine semantic similarity scoring, contextual relationship analysis, and keyword-based matching with configurable weighting. The processing system may dynamically select the number of chunks to combine based on query complexity and relevance thresholds, balancing contextual coverage with computational efficiency.

In some embodiments, the processing system may implement a method for executing an LLM on an edge device with multi-chunk information fusion. The processing system may operate an SSM to maintain multiple stored hidden state obtained through precomputations that compactly store information from different sources processed during previous network exposures.

In some embodiments, the processing system may precompute input contexts from multiple text sources for the LLM, a process referred to as multi-chunk precognition or multi-chunk precog. The processing system may store the precomputed contexts as compact hidden state representations prior to runtime and may combine them mathematically during runtime without reprocessing the original information sources.

In some embodiments, the processing system may receive an input query and may process the query by retrieving multiple relevant hidden states. The processing system may combine the retrieved hidden states using weighted fusion to construct a unified contextual representation. This operation may reduce the demand for burst computation and high-speed memory while supporting synthesis of information from multiple sources.

In some embodiments, the processing system may generate a response based on the combined input query and the fused hidden states. The generative phase may require the creation of a relatively small number of tokens while incorporating information from multiple sources. By limiting runtime token processing and reusing stored hidden state obtained through precomputations, the processing system may reduce computational demand on the edge device.

In some embodiments, the processing system may store multiple associated keys derived from transformations of the original information sources into compressed vector forms. In some cases, the processing system may generate the keys by computing sentence embeddings for each chunk.

In some embodiments, the processing system may implement a multi-stage scoring process to accelerate retrieval. The processing system may combine semantic similarity scoring, contextual relationship analysis, and keyword-based relevance matching with configurable weighting. The processing system may also dynamically select the number of chunks to combine based on query complexity and relevance thresholds, balancing contextual coverage with computational efficiency.

In some embodiments, the processing system may implement a method for executing an LLM on an edge device with multi-chunk fusion using self-keys. Each hidden state may be configured as auto-keying so that the hidden state forms its own key for efficient retrieval.

In some embodiments, the processing system may implement a matching mechanism to compute similarity measures between the hidden state of the input query and multiple stored hidden state obtained through precomputations associated with different chunks. The similarity measures may include dot products, hand-crafted similarity measures, learned similarity measures, or hybrid combinations of these approaches.

In some embodiments, the processing system may mathematically fuse multiple selected hidden states using a weighted combination. The processing system may calculate the weights based on the similarity measures.

In some embodiments, the processing system may implement query-adaptive weight calculation. The query-adaptive weight calculation may automatically increase the contribution of the most relevant chunks based on real-time relevance analysis.

In some embodiments, the processing system may implement a method for executing an LLM on an edge device with multi-chunk fusion that includes integration with a microphone and a voice-to-text algorithm. The processing system may process spoken queries through the voice-to-text algorithm and may synthesize information across multiple sources to generate a response.

In some embodiments, the processing system may operate in conjunction with one or more feedback devices. The feedback devices may include synthetic voice output, a visual display, a tactile display, or another auditory interface. The processing system may generate responses that incorporate information from multiple sources and may deliver the responses to the user through these feedback devices.

In some embodiments, the processing system may provide real-time processing capabilities that support interactive multi-source query handling. The processing system may generate responses suitable for conversational interfaces and accessibility applications that require information synthesis across multiple knowledge sources.

In some embodiments, the processing system may implement a method for executing an LLM on an edge device with multi-chunk fusion that includes integration with a microphone and a voice-to-text algorithm. The processing system may process spoken queries through the voice-to-text algorithm and may synthesize information across multiple sources to generate a response. The processing system may also operate in conjunction with feedback devices such as synthetic voice output, a visual display, a tactile display, or another auditory interface. The processing system may generate responses that incorporate information from multiple sources and may deliver the responses through one or more of the feedback devices. In some embodiments, the processing system may provide real-time processing that supports interactive query handling. The processing system may generate responses suitable for conversational interfaces and accessibility applications that require synthesis across multiple knowledge sources.

In some embodiments, as described in example implementations below, the processing system executing a multi-source precog method may achieve performance improvements compared to a single-source implementation or transformer-based alternatives. The processing system may maintain efficient token generation rates while avoiding reprocessing of entire document collections for each query. The memory footprint may increase sub-linearly with the number of sources combined, preserving orders of magnitude advantage over transformer models that require complete model loading for equivalent multi-document processing.

In some embodiments, the processing system may also provide advantages compared to alternative methods for combining multiple information sources. In one alternative, a system may attempt to process multiple retrieved chunks through the complete LLM pipeline at query time. Such a method may abandon the precomputation benefits of precog by concatenating multiple information sources with the user query and processing the entire sequence through the SSM from initialization. This approach may require reloading billions of parameters for each token across multiple chunks, thereby increasing processing time from seconds to minutes and consuming memory bandwidth beyond the limits of edge devices.

In some embodiments, alternative methods for combining multiple hidden states associated with different information sources may involve offloading multi-chunk queries to cloud infrastructure. In such an alternative, the processing system on the edge device may transmit the query and related context to a cloud server for analysis, while continuing to execute single-chunk retrieval locally. A cloud server may perform multi-chunk reprocessing, transformer-based multi-document analysis, and complex attention operations without memory constraints.

Although such offloading may leverage abundant cloud resources, it may undermine the advantages of edge deployment. Network communication introduces latency, often on the order of 100 to 500 milliseconds, which may degrade responsiveness for interactive use cases. The multi-source precog systems described herein provide advantages over this approach by retaining computation on the edge device. By fusing stored hidden state obtained through precomputations locally, the processing system may preserve precog efficiency and avoid latency penalties while generating multi-source responses with quality comparable to cloud-based analysis.

In some embodiments, the processing system may operate the multi-source architecture on cost-effective standard-performance memory such as DDR4 or DDR5 SDRAM, rather than high-bandwidth memory components. This configuration may permit deployment of the processing system on edge devices with constrained resources while maintaining efficient query processing.

In some embodiments, the processing system may address limitations of single-source precog implementations while maintaining the computational advantages of precog processing. A single-source configuration may require sequential queries or may provide incomplete responses when the requested information spans multiple sources. By contrast, the processing system executing a multi-source fusion system may synthesize information from multiple sources in a single query cycle. The processing system may preserve the mathematical properties of the SSM when combining multiple hidden states so that the computational behavior of multi-source fusion remains consistent with single-source processing.

In some embodiments, the processing system may implement adaptive weight calculation during fusion. The processing system may emphasize the most relevant sources based on real-time relevance analysis rather than requiring manual selection or sequential refinement. This adaptive weighting may allow the processing system to process queries that require comparison, correlation, or analysis across multiple domains. The processing system may provide balanced responses while maintaining processing efficiency suited for deployment on edge devices.

In some embodiments, an edge device may execute an SSM for RAG to provide on-device natural language responses. The processing system may receive tokens from text entry or voice input, embed the tokens, and retrieve one or more stored hidden state obtained through precomputations from memory using a key. A fused hidden state may be formed when multiple sources are relevant. The SSM may initialize from the hidden state, advance across the query tokens, and form output tokens. The device may present the output tokens on a display or may render them as audio through a speaker.

These operations may improve the performance of the device by, for example, reducing memory traffic, latency, and power use. Compact hidden states may replace large context sequences and allow the device to operate within standard memory limits. Measurements described in this specification show examples of reduced footprint and faster response time compared to transformer-based caches. The same path may extend to voice interaction, multi-source fusion, or interactive editing through rollback of hidden states, all while maintaining low latency.

The disclosed arrangements may be realized as methods, systems, or storage media. A method may include receiving a query, embedding tokens, retrieving and initializing with a hidden state, advancing the SSM across query tokens, and providing the output through the device interface. A system may include an SoC, memory, an SSM with fixed-length hidden state, and output interfaces such as a display or speaker. A storage medium may store instructions that configure the processing system to perform these steps. Inputs may include text or speech or other tokens, outputs may include visual or audio or tactile presentation, and operation order or combinations may vary while remaining consistent with these teachings.

In some embodiments, the disclosed subject matter may be realized in any suitable form, including methods performed by a processing system, systems that integrate hardware and software components, computer-readable media that store instructions to configure such systems, or devices that present inputs and outputs through visual, audio, or tactile interfaces, with variations in order, combination, or implementation all considered within the scope of this disclosure.

In some embodiments, the disclosed subject matter may be applied to different technical purposes within defined fields of technology. For example, the processing system may be configured for on-device natural language processing to support text query response, for speech interaction to process audio input and generate spoken output, for medical monitoring to analyze physiological signals such as heart rate or respiration, or for video analysis to process image or video streams for detection or classification tasks. In each case, the technical effect may include reduced memory traffic, lower latency, and decreased power consumption during sequence processing, which may enable real-time responses on devices with constrained resources. The same subject matter may also extend to other domains where compact hidden states and efficient sequence handling improve the operation of a computing device.

FIG. 9 is a component block diagram of an edge device 900 suitable for use with various embodiments. With reference to FIGS. 1-9, various embodiments may be implemented on a variety of edge devices, an example of which is illustrated in FIG. 9 as a wearable computing device in the form of a headset 900. A headset 900 may include a SoC 100 coupled to memory 902 (e.g., DDR4/DDR5 SDRAM, etc.), an antenna 904, a wireless transceiver 906, a speaker 908, and a microphone 910, any or all of which may be coupled to each other and/or to one or more processors 120-132 in the SoC 100. The memory 902 may include standard-performance memory, high-performance memory, volatile memory, non-volatile memory, dynamic memory, static memory, or any combination thereof (e.g., static memory and standard-performance volatile memory, etc.).

FIG. 10 is a component block diagram of an edge device 1000 suitable for use with various embodiments. With reference to FIGS. 1-10, various embodiments may be implemented on a variety of edge devices, an example of which is illustrated in FIG. 10 in the form of a laptop computer 1000. A laptop 1000 may include a SoC 100 and/or a processor 1002 coupled to a memory 1004, which may include standard-performance memory, high-performance memory, volatile memory, non-volatile memory, dynamic memory, static memory, or any combination thereof. For example, memory 1004 may include dynamic random-access memory (DRAM) for volatile storage and non-volatile memory such as flash or solid-state storage, such as a Non-Volatile Memory Express (NVMe) solid-state drive (SSD) 1006. The laptop 1000 may include multiple antennas 1010 designed to support various wireless communication standards, including Wi-Fi 6/6E, 5G cellular connectivity, and Bluetooth. These antennas are connected to a wireless data link and a cellular transceiver 1012, both of which are coupled to the processor 1002. In addition, the laptop 1000 may include a precision touchpad 1008 that supports multi-touch gestures and other modern input/output peripherals, such as a backlit keyboard 1018 and a high-resolution display 1020 (e.g., 4K OLED or Mini-LED). The laptop 1000 may also include biometric sensors for authentication, such as a fingerprint reader or facial recognition, all of which are integrated and controlled by the processor 1002.

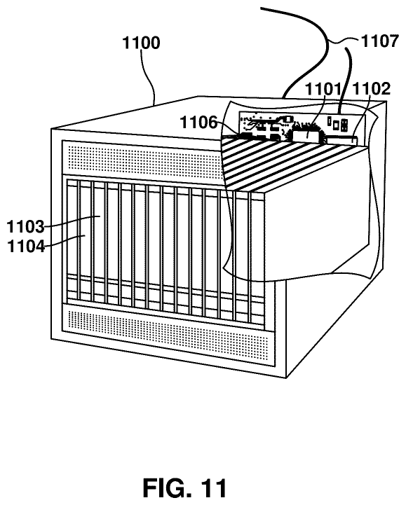

All or portions of some embodiments may be implemented in the cloud or on a variety of commercially available computing devices, such as the server computing device 1100 illustrated in FIG. 11. The server device 1100 may include one or more processors 1101 (e.g., multi-core processor, etc.) coupled to volatile memory 1102, such as RAM, and a large capacity nonvolatile memory, such as a solid-state drive (SSD) 1103. The server device 1100 may also include additional storage interfaces, such as USB ports and NVMe slots, coupled to the processor 1101. The server device 1100 may include network access ports 1106 coupled to the processor 1101 that allow data connections through a network interface card (NIC) 1104 and a communication network 1107 (e.g., an Internet Protocol (IP) network) connected to other network elements.

For the sake of clarity and ease of presentation, the methods discussed in this application are presented as separate embodiments. While each method is delineated for illustrative purposes, it should be clear to those skilled in the art that various combinations or omissions of these methods, blocks, operations, etc., could be used to achieve a desired result or a specific outcome. It should also be understood that the descriptions herein do not preclude the integration or adaptation of different embodiments of the methods, blocks, operations, etc., from producing a modified or alternative result or solution. The presentation of individual methods, blocks, operations, etc., should not be interpreted as mutually exclusive, limiting, or as being required unless expressly recited as such in the claims.

The processors discussed in this application may be any programmable microprocessor, microcomputer, or a combination of multiple processor chips configured by software instructions (applications) to perform diverse functions, including those of the various embodiments described herein. Servers often include multiple processors, with dedicated processors for specific tasks such as managing cloud computing operations, data analytics, or wireless communication functions. Software applications may be stored in the internal memory before being accessed and executed by the processor. Modern processors may include extensive internal memory, often augmented with fast access cache memory, to efficiently store and process application software instructions.

Implementation examples are described in the following paragraphs. While some of the following implementation examples are described in terms of example methods, further example implementations may include: the example methods discussed in the following paragraphs implemented by a computing system including a processor configured (e.g., with processor-executable instructions) to perform operations of the methods of the following implementation examples; the example methods discussed in the following paragraphs implemented by a computing system including means for performing functions of the methods of the following implementation examples; the example methods discussed in the following paragraphs may be implemented as a non-transitory processor-readable storage medium having stored thereon processor-executable instructions configured to cause a processor of a computing system to perform the operations of the methods of the following implementation examples; and the example methods discussed in the following paragraphs may be implemented as a non-transitory processor-readable storage medium having stored thereon data and configurations to control a state machine or cause a processor to perform the operations of the methods of the following implementation examples.
Example 1: A method performed by a processing system of an edge device that executes a first state-space model, accesses a vector database stored in dynamic random-access memory, and includes on-chip static random-access memory for model state, the method including processing a plurality of document chunks through the first state-space model to form a plurality of hidden states, computing, for each document chunk, a corresponding key, storing, in the vector database, a plurality of tuples, each tuple including a key and a hidden state, receiving, by the processing system, a first query, computing a query key for the first query, retrieving, from the vector database, a set of tuples selected by a nearest-neighbor search that uses the stored keys and the query key, computing a fused hidden state by applying a fusion function across hidden states of the set of tuples, loading the fused hidden state into the on-chip static random-access memory of the edge device as an initialization state of the first state-space model, processing tokens of the first query through the first state-space model from the initialization state, and generating answer tokens as a function of the fused hidden state and the tokens of the first query.
Example 2: The method of example 1, in which the fusion function computes a weighted sum across the hidden states of the set of tuples.
Example 3: The method of any of the examples 1-2, in which computing the weighted sum includes applying relevance weights that depend on a lexical scorer and a semantic scorer and a QA relevance ranker.
Example 4: The method of any of the examples 1-3, in which the fusion function applies identical relevance weights across layers of the first state-space model.
Example 5: The method of any of the examples 1-4, in which the fusion function applies per-layer weights derived from global relevance weights.
Example 6: The method of any of the examples 1-5, in which the processing system performs retrieval of the set of tuples as a stream layer by layer and accumulates the fused hidden state per layer to reduce memory footprint.
Example 7: The method of any of the examples 1-6, in which the processing system dynamically selects a number of tuples for fusion in response to a coverage metric that depends on a spread of relevance scores.
Example 8: The method of any of the examples 1-7, in which computing each key includes applying a linear projection to the corresponding hidden state.
Example 9: The method of any of the examples 1-8, in which computing each key includes computing a sentence-embedding vector.
Example 10: The method of any of the examples 1-9, in which the processing system executes the first state-space model on a neural processing unit or a digital signal processor or a graphics processing unit of the edge device.
Example 11: In some embodiments, the processing system may implement a proof-of-concept multi-source system using a knowledge base constructed from movie transcripts to demonstrate multi-chunk hidden state fusion. The processing system may execute a multi-stage retrieval process with layer-wise mathematical fusion across 24 TENNs layers. The processing system may operate a 2048-dimensional SSM with stored hidden state obtained through precomputations organized into semantic clusters such as characters, locations, objects, plot events, and relationships. This implementation may demonstrate that multi-source fusion techniques applied to narrative transcripts correspond to real-world use cases. Complex narrative queries may correspond to legal document analysis requiring multi-source synthesis. Relationship mapping may correspond to organizational knowledge systems. Object interaction queries may correspond to technical documentation requiring integration of safety, operational, and maintenance data. Content aggregation tasks may correspond to training and support systems that require integration of information across multiple domains.
Example 12: In some embodiments, the processing system may demonstrate performance metrics that distinguish the multi-source system from conventional alternatives. The processing system may process queries across multiple sources at approximately 20 tokens per second, compared to more than 1000 tokens per second for conventional systems. The processing system may maintain an 8 KB memory footprint compared to more than 8 MB for transformer-based systems. The processing system may respond to complex queries in approximately three seconds compared to minutes for conventional systems, while also reducing power consumption compared to cloud-based or full-reprocessing systems.
Example 13: In some embodiments, the processing system may process queries using text chunks as information sources. The processing system may encode queries with a 768-dimensional sentence transformer, perform indexing for vector search, and dynamically retrieve three to five chunks based on query complexity. The processing system may assign 45 percent weight to cross-encoder re-ranking, 30 percent to BM25Plus lexical scoring, and 25 percent to cosine similarity. The processing system may combine 2048-dimensional hidden states across 24 TENNs layers using the formula: Combined_Hidden_State[layer_idx]=Σ(weight_i×hidden_state_i[layer_idx]).

This configuration may allow the processing system to generate tokens at approximately 20 tokens per second with a 24-40 KB memory footprint for typical multi-chunk operations, maintaining a memory advantage of approximately 1000 times compared to transformer-based systems that require more than 8 MB.
Example 14: In some embodiments, the processing system may demonstrate improvements in query processing latency and computational efficiency compared to conventional systems. The processing system may complete multi-source queries in seconds, whereas conventional systems that load and process multiple documents through complete neural pipelines may require minutes. The processing system may maintain rapid response times for simple queries while scaling to handle complex analysis across multiple sources without exceeding the computational limits of an edge device. The processing system may also eliminate burst processing and high-speed memory access patterns characteristic of conventional multi-document systems. By precomputing and storing hidden states offline, the processing system may reduce real-time operations from billions of parameter computations to compact mathematical fusion of hidden states. This reduction may allow the processing system to deliver multi-source synthesis in real-time on an edge device with reduced power use, lower memory footprint, and improved runtime stability.

As used in this application, terminology such as “component,” “module,” “system,” etc., is intended to encompass a computer-related entity. These entities may involve, among other possibilities, hardware, firmware, a blend of hardware and software, software alone, or software in an operational state. As examples, a component may encompass a running process on a processor, the processor itself, an object, an executable file, a thread of execution, a program, or a computing device. To illustrate further, both an application operating on a computing device and the computing device itself may be designated as a component. A component might be situated within a single process or thread of execution or could be distributed across multiple processors or cores. In addition, these components may operate based on various non-volatile computer-readable media that store diverse instructions and/or data structures. Communication between components may take place through local or remote processes, function, or procedure calls, electronic signaling, data packet exchanges, memory interactions, among other known methods of network, computer, processor, or process-related communications.

A variety of memory types and technologies, both currently available and anticipated for future development, may be incorporated into systems and computing devices that implement the various embodiments. These memory technologies may include non-volatile random-access memories (NVRAM) such as magnetoresistive RAM (MRAM), resistive random-access memory (ReRAM or RRAM), phase-change memory (PCM, PC-RAM, or PRAM), ferroelectric RAM (FRAM), spin-transfer torque magnetoresistive RAM (STT-MRAM), and three-dimensional cross-point (3D XPoint) memory. Non-volatile or read-only memory (ROM) technologies may also be included, such as programmable read-only memory (PROM), field programmable read-only memory (FPROM), and one-time programmable non-volatile memory (OTP NVM). Volatile random-access memory (RAM) technologies may further be utilized, including dynamic random-access memory (DRAM), double data rate synchronous dynamic random-access memory (DDR SDRAM), static random access memory (SRAM), and pseudostatic random-access memory (PSRAM). Additionally, systems and computing devices implementing these embodiments may use solid-state non-volatile storage mediums, such as FLASH memory. The aforementioned memory technologies may store instructions, programs, control signals, and/or data for use in computing devices, SoC components, or other electronic systems. Any references to specific memory types, interfaces, standards, or technologies are provided for illustrative purposes and do not limit the claims to any particular memory system or technology unless explicitly recited in the claim language.

The foregoing method descriptions and the process flow diagrams are provided merely as illustrative examples and are not intended to require or imply that the blocks of the various aspects must be performed in the order presented. As may be appreciated by one of skill in the art, the order of steps in the foregoing aspects may be performed in any order. Words such as “thereafter,” “then,” “next,” etc., are not intended to limit the order of the blocks; these words are simply used to guide the reader through the description of the methods. Further, any reference to claim elements in the singular, for example, using the articles “a,” “an,” or “the,” is not to be construed as limiting the element to the singular.

The various illustrative logical blocks, modules, circuits, and algorithmic steps described in connection with the aspects disclosed herein may be implemented as electronic hardware, computer software, or combinations of both. To clearly illustrate the interchangeability of hardware and software, various components, blocks, modules, circuits, and steps have been described in terms of their functionality. Whether such functionality is implemented as hardware or software may depend on the specific application and the design constraints of the overall system. Skilled artisans may implement the described functionality in different ways for each particular application, and such implementation decisions should not be interpreted as limiting or altering the scope of the claims unless explicitly recited in the claim language.

The hardware used to implement the various illustrative logics, logical blocks, modules, and circuits described in connection with the embodiments disclosed herein may include or be performed by a general-purpose processor, a digital signal processor (DSP), an application-specific integrated circuit (ASIC), a field-programmable gate array (FPGA), a graphics processing unit (GPU), a tensor processing unit (TPU), or other programmable logic devices, discrete gate or transistor logic, discrete hardware components, or any combination thereof, designed to perform the functions described. A general-purpose processor may be a microprocessor, or alternatively, it may be any conventional processor, controller, microcontroller, or state machine. A processor may also be implemented as a combination of computing devices, such as a DSP combined with a microprocessor, multiple microprocessors, one or more microprocessors used in conjunction with a DSP core, a GPU, or AI accelerators such as TPUs. Alternatively, some operations or methods may be performed by circuitry designed specifically for a given function.

In one or more embodiments, the functions described may be implemented in hardware, software, firmware, or any combination thereof. If implemented in software, the functions may be stored as one or more instructions or code on a non-transitory computer-readable medium or non-transitory processor-readable medium. The operations of a method or algorithm disclosed herein may be embodied in a processor-executable software module that resides on a non-transitory computer-readable or processor-readable storage medium. Non-transitory computer-readable or processor-readable storage media include any storage media that may be accessed by a computer or processor. By way of example, but not limitation, such non-transitory computer-readable or processor-readable media may include RAM, ROM, EEPROM, flash memory, SSDs, NVMe drives, 3D NAND flash, or any other medium capable of storing program code in the form of instructions or data structures that may be accessed by a computer. Cloud-based storage solutions, including infrastructure-as-a-service (IaaS) platforms, may provide scalable and distributed options for storing and accessing program code. In addition, the operations of a method or algorithm may reside as one or more sets of instructions or code on a non-transitory processor-readable or computer-readable medium, which may be incorporated into a computer program product. Emerging technologies, such as quantum computing storage media and blockchain-based storage solutions, may enhance data integrity and security. AI and ML-improved hardware accelerators, such as GPUs, TPUs, and other dedicated processing units, may be used to efficiently execute complex algorithms.

The preceding description of the disclosed aspects is provided to enable any person skilled in the art to make or use the claims. Various modifications to these aspects may be apparent to those skilled in the art, and the generic principles defined herein may be applied to other aspects without departing from the scope of the claims. Thus, the present disclosure is not intended to be limited to the aspects shown herein but is to be accorded the widest scope consistent with the following claims and the principles and novel features disclosed herein.

What is claimed is:

1. A method performed by a processing system of a computing device that executes a first state-space model, accesses a vector database stored in dynamic random-access memory, and includes on-chip static random-access memory for model state, the method comprising:
processing a plurality of document chunks through the first state-space model to form a plurality of hidden states;
computing, for each document chunk, a corresponding key;
storing, in the vector database, a plurality of tuples, each tuple including a key and a hidden state;
receiving, by the processing system, a first query;
computing a query key for the first query;
retrieving, from the vector database, a set of tuples selected by a nearest-neighbor search that uses the stored keys and the query key;
computing a fused hidden state by applying a fusion function across hidden states of the set of tuples;
loading the fused hidden state into the on-chip static random-access memory of the computing device as an initialization state of the first state-space model;
processing tokens of the first query through the first state-space model from the initialization state; and
generating answer tokens as a function of the fused hidden state and the tokens of the first query.

2. The method of claim 1, wherein the fusion function computes a weighted sum across the hidden states of the set of tuples.

3. The method of claim 2, wherein computing the weighted sum includes applying relevance weights that depend on a lexical scorer and a semantic scorer and a QA relevance ranker.

4. The method of claim 1, wherein the fusion function applies identical relevance weights across layers of the first state-space model.

5. The method of claim 1, wherein the fusion function applies per-layer weights derived from global relevance weights.

6. The method of claim 1, wherein the processing system performs retrieval of the set of tuples as a stream layer by layer and accumulates the fused hidden state per layer to reduce memory footprint.

7. The method of claim 1, wherein the processing system dynamically selects a number of tuples for fusion in response to a coverage metric that depends on a spread of relevance scores.

8. The method of claim 1, wherein computing each key includes applying a linear projection to the corresponding hidden state.

9. The method of claim 1, wherein computing each key includes computing a sentence-embedding vector.

10. The method of claim 1, wherein the processing system executes the first state-space model on a neural processing unit (NPU), a digital signal processor (DSP), or a graphics processing unit (GPU) of the computing device.

11. A computing device, comprising:
a processing system;
a memory system;
a vector database accessible to the processing system; and
a first state-space model executable by the processing system;
wherein the processing system is configured to:
process a plurality of document chunks through the first state-space model to form a plurality of hidden states;
compute, for each document chunk, a corresponding key;
store, in the vector database, a plurality of tuples that each include a key and a hidden state;
receive a first query;
compute a query key for the first query;
retrieve, from the vector database, a set of tuples selected by a nearest-neighbor search that uses the stored keys and the query key;
compute a fused hidden state by applying a fusion function across hidden states of the set of tuples;
initialize the first state-space model with the fused hidden state as an initialization state;
process tokens of the first query through the first state-space model from the initialization state; and
generate answer tokens as a function of the fused hidden state and the tokens of the first query.

12. The computing device of claim 11, wherein the memory system includes dynamic random-access memory that stores the vector database and on-chip static random-access memory that stores an active hidden state.

13. The computing device of claim 11, wherein the processing system executes the first state-space model on an accelerator selected from a neural processing unit (NPU), a digital signal processor (DSP), or a graphics processing unit (GPU) and transfers the fused hidden state by direct memory access into per-layer static random-access memory locations of the accelerator.

14. The computing device of claim 11, wherein the processing system computes the fused hidden state by a weighted sum across hidden states of the set of tuples with weights computed by a lexical scorer, a semantic scorer, and a cross-encoder.

15. The computing device of claim 11, wherein the first state-space model is a Temporal Event-Based Neural Network (TENN) model and wherein the fused hidden state includes one per-layer vector.

16. A non-transitory processor-readable storage medium having stored thereon data and configurations to control a state machine or cause a processing system in a computing device to perform operations comprising:
processing a plurality of document chunks through a first state-space model to form a plurality of hidden states;
computing, for each document chunk, a corresponding key;
storing, in a vector database, a plurality of tuples that each include a key and a hidden state;
receiving a first query;
computing a query key for the first query;
retrieving, from the vector database, a set of tuples selected by a nearest-neighbor search that uses the stored keys and the query key;
computing a fused hidden state by applying a fusion function across hidden states of the set of tuples;
loading the fused hidden state into on-chip static random-access memory of the computing device as an initialization state of the first state-space model;
processing tokens of the first query through the first state-space model from the initialization state; and
generating answer tokens as a function of the fused hidden state and the tokens of the first query.

17. The non-transitory processor-readable storage medium of claim 16, wherein the operations include computing the fused hidden state by a weighted sum across hidden states of the set of tuples.

18. The non-transitory processor-readable storage medium of claim 16, wherein the operations include performing retrieval of the set of tuples by cosine similarity and dynamically selecting a number of tuples based on a coverage metric.

19. The non-transitory processor-readable storage medium of claim 16, wherein the operations include computing each key as a sentence-embedding vector and computing the query key with a same sentence-embedding model.

20. The non-transitory processor-readable storage medium of claim 16, wherein the operations include storing each tuple as contiguous arrays of floating-point values in dynamic random-access memory and loading the fused hidden state into per-layer static random-access memory by direct memory access.

21. A method performed by a processing system of a computing device that executes a first state-space model, accesses a vector database stored in dynamic random-access memory and includes on-chip static random-access memory for model state, the method comprising:
processing a first document chunk through the first state-space model to form a first hidden state;
computing a first key for the first document chunk;
storing, in the vector database, a first tuple that includes the first key and the first hidden state;
receiving, by the processing system, a first query;
computing a query key for the first query;
retrieving the first tuple from the vector database by a nearest neighbor search that uses the first key and the query key;
loading the first hidden state into the on-chip static random-access memory of the computing device as an initialization state of the first state-space model;
processing tokens of the first query through the first state-space model from the initialization state; and
generating answer tokens as a function of the initialization state and the tokens of the first query without reprocessing tokens of the first document chunk.

22. The method of claim 21, further comprising computing the first key as a sentence-embedding vector.

23. The method of claim 21, further comprising computing the first key by applying a linear projection to the first hidden state.

24. The method of claim 21, further comprising computing the first key by applying a multilayer perceptron with fixed parameters to the first hidden state.

25. The method of claim 21, further comprising storing the first tuple as two contiguous arrays of floating-point values in dynamic random-access memory.

26. The method of claim 21, further comprising performing the nearest neighbor search by cosine similarity and selecting a highest-scored tuple.

27. The method of claim 21, further comprising processing the first query through the first state-space model to form a query hidden state and computing the query key by applying a same function used to compute the first key to the query hidden state.

28. The method of claim 21, further comprising storing the first tuple as non-text numeric arrays that encode the first document chunk by the first key and the first hidden state.

29. The method of claim 21, further comprising executing the first state-space model on a neural processing unit (NPU), a digital signal processor (DSP), or a graphics processing unit (GPU) of the computing device.

30. The method of claim 21, further comprising transferring the first hidden state by direct memory access into per-layer static random-access memory locations of an accelerator of the computing device before a first token of the first query enters the first state-space model.

31. A computing device, comprising:
a processing system;
a memory system,
a vector database accessible to the processing system; and
a first state-space model executable by the processing system,
wherein the processing system is configured to:
process a first document chunk through the first state-space model to form a first hidden state;
compute a first key for the first document chunk;
store, in the vector database, a first tuple that includes the first key and the first hidden state;
receive a first query;
compute a query key for the first query;
retrieve the first tuple from the vector database by a nearest neighbor search that uses the first key and the query key;
initialize the first state-space model with the first hidden state as an initialization state;
process tokens of the first query through the first state-space model from the initialization state; and
generate answer tokens as a function of the initialization state and the tokens of the first query.

32. The computing device of claim 31, wherein the memory system includes dynamic random-access memory that stores the vector database and on-chip static random-access memory that stores an active hidden state.

33. The computing device of claim 31, wherein the processing system includes an accelerator selected from a neural processing unit (NPU), a digital signal processor (DSP), or a graphics processing unit (GPU) and wherein the processing system transfers the first hidden state by direct memory access into per-layer static random-access memory locations of the accelerator.

34. The computing device of claim 31, wherein the processing system performs the nearest neighbor search by cosine similarity and scales each key to unit length before the cosine similarity.

35. The computing device of claim 31, wherein the processing system computes the first key as a sentence-embedding vector and computes the query key with a same sentence-embedding model.

36. The computing device of claim 31, wherein the first state-space model is a TENNs model and wherein the initialization state includes one per-layer vector.

37. A non-transitory processor-readable storage medium having stored thereon data and configurations to control a state machine or cause a processing system to perform operations comprising:
processing a first document chunk through a first state-space model to form a first hidden state;
computing a first key for the first document chunk;
storing, in a vector database, a first tuple that includes the first key and the first hidden state;
receiving a first query;
computing a query key for the first query;
retrieving the first tuple from the vector database by a nearest neighbor search that uses the first key and the query key;
initializing the first state-space model with the first hidden state as an initialization state;
processing tokens of the first query through the first state-space model from the initialization state; and
generating answer tokens as a function of the initialization state and the tokens of the first query.

38. The non-transitory processor-readable storage medium of claim 37, wherein the operations include computing the first key by a linear projection of the first hidden state and computing the query key by the same linear projection.

39. The non-transitory processor-readable storage medium of claim 37, wherein the operations include storing the first tuple as two contiguous arrays of floating-point values in dynamic random-access memory and loading the first hidden state into on-chip static random-access memory as the initialization state.

40. The non-transitory processor-readable storage medium of claim 37, wherein the operations include performing the nearest neighbor search by cosine similarity and selecting a tuple that exceeds a similarity threshold.

41. A method performed by a processing system of a computing device, the method comprising:
processing a corpus through a first state-space model to form a stored hidden state;
computing a retrieval index vector for the corpus;
storing, in a vector database, a tuple that includes an identifier for the corpus, the retrieval index vector, and the stored hidden state;
receiving a user query and a selection of the identifier;
retrieving the tuple by the identifier;
loading the stored hidden state into on-chip static random-access memory of the computing device as an initialization state of the first state-space model;
processing tokens of the user query from the initialization state; and
generating answer tokens.

42. The method of claim 41, wherein loading the stored hidden state includes:
direct memory access that copies one per-layer vector into per-layer static random-access memory locations of a neural processing unit (NPU), a digital signal processor (DSP), or a graphics processing unit (GPU).

43. The method of claim 41, further comprising storing multiple tuples for multiple corpora and switching context by retrieving and loading the stored hidden state of a different tuple in response to a user selection.

44. The method of claim 41, further comprising retrieving multiple stored hidden states for multiple corpora and forming a combined hidden state by a fusion function that computes a weighted sum per layer or applies a learned per-layer mapper before load.

45. A computing device, comprising:
a processing system;
a memory system,
a vector database accessible to the processing system; and
a first state-space model executable by the processing system,
wherein the processing system is configured to:
process a corpus through a first state-space model to form a stored hidden state;
compute a retrieval index vector for the corpus;
store, in a vector database, a tuple that includes an identifier for the corpus, the retrieval index vector, and the stored hidden state;
receive a user query and a selection of the identifier;
retrieve the tuple by the identifier;
load the stored hidden state into on-chip static random-access memory of the computing device as an initialization state of the first state-space model;
process tokens of the user query from the initialization state; and
generate answer tokens.

46. The computing device of claim 45, wherein loading the stored hidden state includes direct memory access that copies one per-layer vector into per-layer static random-access memory locations of a neural processing unit (NPU), a digital signal processor (DSP), or a graphics processing unit (GPU).

47. The computing device of claim 45, wherein the processing system is further configured to store multiple tuples for multiple corpora and to switch context by retrieving and loading the stored hidden state of a different tuple in response to a user selection.

48. The computing device of claim 45, wherein the processing system is further configured to retrieve multiple stored hidden states for multiple corpora and forming a combined hidden state by a fusion function that computes a weighted sum per layer or applies a learned per-layer mapper before load.

49. A non-transitory processor-readable storage medium having stored thereon data and configurations to control a state machine or cause a processing system to perform operations comprising:
processing a corpus through a first state-space model to form a stored hidden state;
computing a retrieval index vector for the corpus;
storing, in a vector database, a tuple that includes an identifier for the corpus, the retrieval index vector, and the stored hidden state;
receiving a user query and a selection of the identifier;
retrieving the tuple by the identifier;
loading the stored hidden state into on-chip static random-access memory of the computing device as an initialization state of the first state-space model;
processing tokens of the user query from the initialization state; and
generating answer tokens.

50. The non-transitory processor-readable storage medium of claim 49, wherein the operations include loading the stored hidden state by direct memory access that copies one per-layer vector into per-layer static random-access memory locations of a neural processing unit (NPU), a digital signal processor (DSP), or a graphics processing unit (GPU).

51. The non-transitory processor-readable storage medium of claim 49, wherein the operations include storing multiple tuples for multiple corpora and switching context by retrieving and loading the stored hidden state of a different tuple in response to a user selection.

52. The non-transitory processor-readable storage medium of claim 49, wherein the operations include retrieving multiple stored hidden states for multiple corpora and forming a combined hidden state by a fusion function that computes a weighted sum per layer or applies a learned per-layer mapper before load.
